(19) United States
(12) Patent Application Publication
(10) Pub. No.: US 2026/0156217 A1
(43) Pub. Date: Jun. 4, 2026

(54) SHEET FEEDING DEVICE, IMAGE READING DEVICE, AND IMAGE FORMING APPARATUS

(71) Applicant: SHARP KABUSHIKI KAISHA, Osaka (JP)

(72) Inventors: YASUMASA MORIMOTO, Osaka (JP); HIRONORI OGASAWARA, Osaka (JP); Masakatsu KUSUDA, Osaka (JP); HIROTOSHI IEMURA, Osaka (JP)

(21) Appl. No.: 19/405,920

(22) Filed: Dec. 2, 2025

(30) Foreign Application Priority Data
Dec. 2, 2024 (JP) 2024-209520

(51) Int. Cl. H04N 1/00

(52) U.S. Cl. CPC H04N 1/00793; H04N 1/00551; H04N 1/00588; H04N 1/00602

(57) ABSTRACT

A sheet feeding device includes a sheet feeder and one or more controllers. The sheet feeder includes a feeding roller, a roller holder, and a sheet stopper movable to a first position where feeding of the sheet is regulated and to a second position where the feeding of the sheet is not regulated. The one or more controllers are allowed to perform a feeding operation of moving a roller holder to a lowered position and feeding the sheet to a sheet conveyance path, and a retracting operation of stopping the feeding operation and moving the roller holder to a raised position. The sheet feeder further includes a holding regulating portion that holds the sheet stopper so as not to move from the second position in a case where the retracting operation is performed in a state where the sheet stopper is located at the second position.

### CROSS-REFERENCE TO RELATED APPLICATION

The present application claims priority from Japanese Application JP2024-209520, the content of which is hereby incorporated by reference into this application.

### BACKGROUND OF THE INVENTION

### 1. Field of the Invention

The disclosure relates to a sheet feeding device, an image reading device, and an image forming apparatus (for example, a copier, a multifunction apparatus, a printer, a facsimile machine device, or the like).

### 2. Description of the Related Art

A sheet feeding device of the related art usually includes a sheet placement portion (document placement tray) on which a sheet (document) having an image formed thereon can be placed, a sheet conveyance path through which the sheet is conveyed, and a sheet feeder that feeds the sheet placed on the sheet placement portion to the sheet conveyance path. As such a sheet feeding device, for example, there is a sheet feeding device in which the sheet feeder includes a feeding roller (nudger roll) that rotates by receiving a rotational driving force from a driving source, a roller holder (swing bracket) that pivotally supports the feeding roller, a raising/lowering mechanism that moves the roller holder to a lowered position where the feeding roller abuts against a sheet placed on a sheet placement portion or to a raised position where the feeding roller is separated from the sheet placed on the sheet placement portion, and a sheet stopper (set gate) that is swingable between a regulating position where feeding of the sheet to a sheet conveyance path is regulated and a non-regulating position where the feeding of the sheet to the sheet conveyance path is not regulated.

### SUMMARY OF THE INVENTION

In such a sheet feeding device of the related art, it is necessary in some cases to position the sheet stopper at a position where swinging from the regulating position to the non-regulating position is regulated during sheet feeding operation, and on the other hand, to position the sheet stopper at a position retracted from the regulating position during a time other than the sheet feeding operation. For example, in a sheet feeding device that includes an opening/closing member (for example, an opening/closing cover member) formed to form a sheet conveyance path in a closed state and opens the sheet conveyance path in an open state, and that is formed such that a feeding roller, a roller holder, and a sheet stopper in a sheet supplier are provided at a lower surface of the opening/closing member, in a case where the opening/closing member is opened and closed when a sheet is jammed and the jammed sheet is not removed, the sheet stopper returns from the non-regulating position to the regulating position, and the sheet stopper presses the sheet from above. In this case, the sheet stopper may damage the sheet and/or the sheet stopper may be broken.

In this regard, the sheet stopper of the related art includes a gate portion against which a tip end of the sheet abuts and a joint portion that supports the gate portion so as to be bendable in a direction opposite to an abutment direction of the tip end of the sheet.

However, in the sheet stopper of the related art, the structure is adopted in which the joint portion supports the gate portion so as to be bendable in the direction opposite to the abutment direction of the tip end of the sheet, and thus the structure is complicated.

Then, an object of an aspect of the disclosure is to provide a sheet feeding device, an image reading device, and an image forming apparatus in which a sheet stopper can be positioned at a position retracted from a regulating position at a time other than sheet feeding operation, despite having a simple structure.

A sheet feeding device according to an aspect of the disclosure, in order to solve the above problem, includes a sheet placement portion on which a sheet is placed, a sheet conveyance path through which the sheet is conveyed, a sheet feeder that feeds the sheet placed on the sheet placement portion to the sheet conveyance path, a conveyed sheet detector that detects the sheet being conveyed through the sheet conveyance path, and one or more controllers, wherein the sheet feeder includes a feeding roller that rotates about a rotation axis by receiving a rotational driving force from a driving source, a roller holder that pivotally supports the feeding roller, a holder mover that moves the roller holder to a lowered position where the feeding roller abuts against the sheet placed on the sheet placement portion or to a raised position where the feeding roller is separated from the sheet placed on the sheet placement portion, and a sheet stopper provided above the sheet placement portion and movable to a first position where feeding of the sheet placed on the sheet placement portion to the sheet conveyance path is regulated and to a second position where the feeding of the sheet placed on the sheet placement portion to the sheet conveyance path is not regulated, the one or more controllers are allowed to perform a feeding operation of moving the roller holder to the lowered position and feeding the sheet placed on the sheet placement portion to the sheet conveyance path by the feeding roller, and a retracting operation of stopping the feeding operation of the feeding roller and moving the roller holder to the raised position in a case where it is determined that the sheet fed by the feeding operation is stopped in the sheet conveyance path based on a detection result of the conveyed sheet detector, and the sheet feeder further includes a holding regulating portion that holds the sheet stopper so as not to move from the second position in a case where the retracting operation is performed in a state where the sheet stopper is located at the second position.

According to an aspect of the disclosure, it is possible to position a sheet stopper at a position retracted from a regulating position at a time other than the sheet feeding operation despite having a simple structure.

### BRIEF DESCRIPTION OF THE DRAWINGS

FIG. 1 is a schematic cross-sectional view of an example of an image forming apparatus including a document feeding device according to the embodiment as viewed from the front.

FIG. 2 is a perspective view illustrating the document feeding device and an image reading device illustrated in FIG. 1.

FIG. 3 is a cross-sectional view illustrating a main part of the document feeding device and the image reading device illustrated in FIG. 1.

FIG. 4 is a perspective view illustrating a state where an opening/closing member is located at an open position in the document feeding device illustrated in FIG. 1.

FIG. 5 is a perspective view in which a portion including a document supplier at a lower surface of the opening/closing member located at the open position is enlarged and illustrated.

FIG. 6 is a perspective view in which a portion including a roller holder at the lower surface of the opening/closing member located at the open position is enlarged and illustrated.

FIG. 7 is a perspective view illustrating a document stopper included in a document feeder.

FIG. 8 is a cross-sectional view of the document stopper as viewed in a direction orthogonal to a first swing shaft portion.

FIG. 9 is a perspective view in which a portion including the document feeder when the document stopper is located at a regulating position (first position) in a state where the roller holder is located at a raised position is enlarged and illustrated.

FIG. 10 is a cross-sectional view obtained by cutting a portion including the document feeder at a place of a stopper portion in the document stopper when the document stopper is located at the regulating position (first position) in a state where the roller holder is located at the raised position.

FIG. 11 is a perspective view illustrating a state where the roller holder is located at a lowered position.

FIG. 12 is a cross-sectional view obtained by cutting the state where the roller holder is located at the lowered position, at a place of an engaging portion of the document stopper and an engaged portion of the roller holder.

FIG. 13 is a cross-sectional view obtained by cutting a portion including the roller holder of the document feeding device during document feeding operation, at a place of the engaging portion of the document stopper and the engaged portion of the roller holder.

FIG. 14 is a cross-sectional view obtained by cutting a state where the roller holder is located at the raised position when a document is jammed at a place of the stopper portion of the document stopper.

FIG. 15 is a perspective view illustrating a state where the roller holder is raised to the raised position when the document stopper is located at a non-regulating position (second position) with the opening/closing member closed to regulate swinging of the document stopper from the non-regulating position to the regulating position (first position).

FIG. 16 is a cross-sectional view illustrating a portion including a placed document detector in a state where a document is not sensed.

FIG. 17 is a cross-sectional view illustrating the portion including the placed document detector in a state where a document is sensed.

FIG. 18 is a schematic block diagram illustrating a system formation of a controller in the document feeding device.

FIG. 19 is a flowchart illustrating an example of a flow of document feeding processing of the controller in the document feeding device.

FIG. 20 is a flowchart illustrating return processing when a document is stopped during document feeding in a first embodiment.

FIG. 21 is an example of a message displayed on a first display screen of an operation display when a document is jammed.

FIG. 22 is a flowchart illustrating an example of a flow of document feeding processing including return processing when a document is stopped during document feeding in a second embodiment.

FIG. 23 is an example of a message displayed on a second display screen of the operation display when a document is jammed.

FIG. 24 is an example of a message displayed on a third display screen of the operation display when a document is jammed.

### DETAILED DESCRIPTION OF THE INVENTION

Embodiments according to the disclosure will be described below with reference to the drawings. In the following description, the same components are denoted by the same reference numerals. Their names and functions are also the same. Accordingly, detailed descriptions thereof will not be repeated.

### Image Forming Apparatus

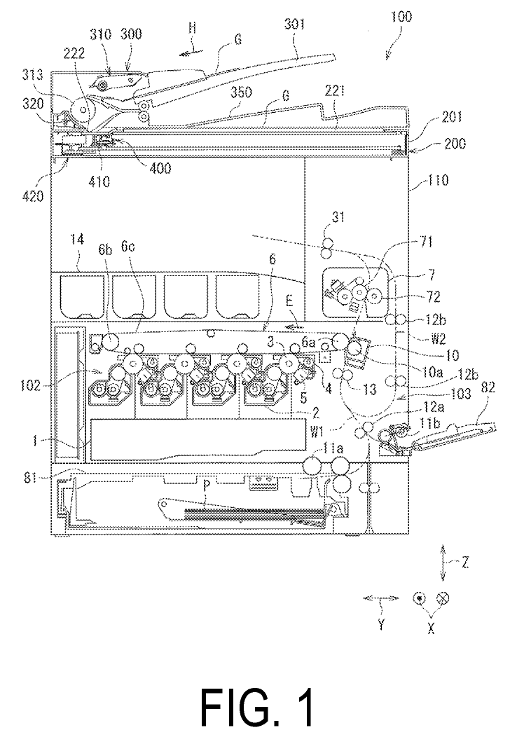

FIG. 1 is a schematic cross-sectional view of an image forming apparatus 100 including an image reading device 200 according to the embodiment as viewed from the front. In the drawings, a reference numeral X denotes a width direction, a reference numeral Y denotes a left-right direction, and a reference numeral Z denotes an up-down direction (vertical direction). Here, in a width direction X illustrated in FIG. 1, a near side in the drawing (with respect to a paper surface) is a front surface of the image forming apparatus 100, and a far side in the drawing (with respect to the paper surface) is a back surface of the image forming apparatus 100. Further, each reference numeral H in FIG. 1 denotes a document feeding direction (transport direction) that is a feeding direction of a document G by a document feeding device 300 (sheet feeding device) described below.

The image forming apparatus 100 according to the embodiment is a color image forming apparatus that forms a multicolor or monochrome image on a sheet P. The image forming apparatus 100 performs image forming processing in accordance with image data read by the image reading device 200 or image data transmitted from the outside. Note that the image forming apparatus 100 may be a monochrome image forming apparatus.

An image forming apparatus body 110 included in the image forming apparatus 100 will be described first.

The image forming apparatus 100 includes the image forming apparatus body 110 to form an image on the sheet P. The image forming apparatus body 110 includes an image former 102 and a sheet conveyor 103.

The image former 102 includes an exposure device 1, a development device 2, a photoreceptor drum 3 that acts as an electrostatic latent image carrier, a cleaning device 4, a charging device 5, a primary transfer device 6, a secondary transfer device 10, and a fixing device 7. Further, the sheet conveyor 103 includes a feed tray 81 that accommodates at least one sheet P on which an image is to be formed, a manual feed tray 82 that accommodates at least one sheet P on which an image is to be formed, a discharge roller 31, and a discharge tray 14.

The sheet conveyor 103 further includes a sheet conveying path W1 to convey the sheets P accommodated in the feed tray 81 or the manual feed tray 82 to the secondary transfer device 10 and the fixing device 7 one by one, and then conveying the sheets P to the discharge tray 14. On the sheet conveying path W1, drawing rollers 11a, 11b, a conveying roller 12a, a registration roller 13, a transfer roller 10a in the secondary transfer device 10, a heat roller 71 and a pressure roller 72 in the fixing device 7, and the discharge roller 31 are located to convey the sheet P.

Next, image formation performed by the image former 102 will be briefly described. In the image former 102, when an image is formed, a surface of the photoreceptor drum 3 uniformly charged by the charging device 5 is exposed to laser light by the exposure device 1 according to image data (image information), and an electrostatic latent image is formed on each photoreceptor drum 3. Each electrostatic latent image formed on the photoreceptor drum 3 is developed by the development device 2 and visualized as a toner image. The toner image on the photoreceptor drum 3 is intermediately transferred onto an intermediate transfer belt 6c that is stretched between a driving roller 6a and a driven roller 6b in the primary transfer device 6, and rotated in a predetermined rotation direction E. The toner image on the intermediate transfer belt 6c rotated in the predetermined rotation direction E is conveyed to the secondary transfer device 10 including the secondary transfer roller 10a. The toner image intermediately transferred onto the intermediate transfer belt 6c is transferred at a transfer nip portion onto the sheet P conveyed from the feed tray 81 or the manual feed tray 82 to the transfer nip portion that is an abutment portion between the intermediate transfer belt 6c and the secondary transfer roller 10a. Here, the sheets P conveyed to the transfer nip portion are the sheets P that are drawn into the sheet conveying path W1 one by one by the drawing roller 11a or 11b among the sheets P accommodated in the feed tray 81 or the manual feed tray 82, and are conveyed so as to be temporarily stopped by the registration roller 13 via the conveying roller 12a. Then, the registration roller 13 restarts the conveyance of the temporarily stopped sheet P toward the transfer nip portion at a timing so as to match the toner image on the intermediate transfer belt 6c. The sheet P on which the toner image is transferred at the transfer nip portion is sent to a fixing nip portion that is an abutment portion between the heat roller 71 having a surface controlled to have a predetermined temperature and the pressure roller 72 that are included in the fixing device 7. The toner image transferred onto the sheet P is melted by heat and pressure at the fixing nip portion and fixed to the sheet P. The sheet P on which the toner image is fixed is subsequently conveyed along the sheet conveying path W1 and is discharged onto the discharge tray 14 via the discharge roller 31. Here, when image formation is performed not only on a front surface but also on a back surface of the sheet P, the sheet P is conveyed in a reverse direction from the discharge roller 31 to a reverse sheet conveying path W2. The sheet P passes through reverse conveying rollers 12b to 12b, and is turned over and guided again to the registration roller 13. Then, after a toner image is formed and fixed on the back surface of the sheet P in the same manner as the front surface, the sheet P is discharged toward the discharge tray 14.

### Image Reading Device

The image reading device 200 included in the image forming apparatus 100 will be described next.

The image reading device 200 to read an image of the document G (a sheet on which an image is formed) is provided at an upper portion of the image forming apparatus body 110. The image reading device 200 includes a document table 221 (sheet table) on which the document G is placed, specifically made of a glass plate, and a document reading plate portion 222 made of glass to read the document G fed by the document feeding device 300 (sheet feeding device) described below.

The image reading device 200 includes an image scanner 400 (specifically, an image reading unit) including an image sensor 410 that reads an image of the document G. The image scanner 400 is provided below the document table 221. The image reading device 200 scans the document G placed on the document table 221 while moving the image scanner 400 from one end (left end) to another end (right end) in a left-right direction Y of the document G along a lower surface of the document table 221. As described above, the image reading device 200 reads an image of the document G placed on the document table 221 with the image sensor 410.

Note that the reciprocating movement in the left-right direction Y of the image scanner 400 with respect to a housing 201 is performed by an image reading unit driver 420. The image reading unit driver 420 includes a motor 420a and a driving belt 420b stretched between a driving pulley rotated by a gear provided at a shaft portion of the motor 420a and a driven pulley (not illustrated). A part of the driving belt 420b is connected to the image scanner 400, and when the motor 420a is rotated, the driving belt 420b is moved via the driving pulley, so that the image scanner 400 can be moved in the left-right direction Y to read the document G. Further, the image scanner 400 can be moved to a lower side of the document reading plate portion 222.

### Document Feeding Device

The document feeding device 300 (sheet feeding device) is provided above the image reading device 200, that is, above the document table 221 and the document reading plate portion 222.

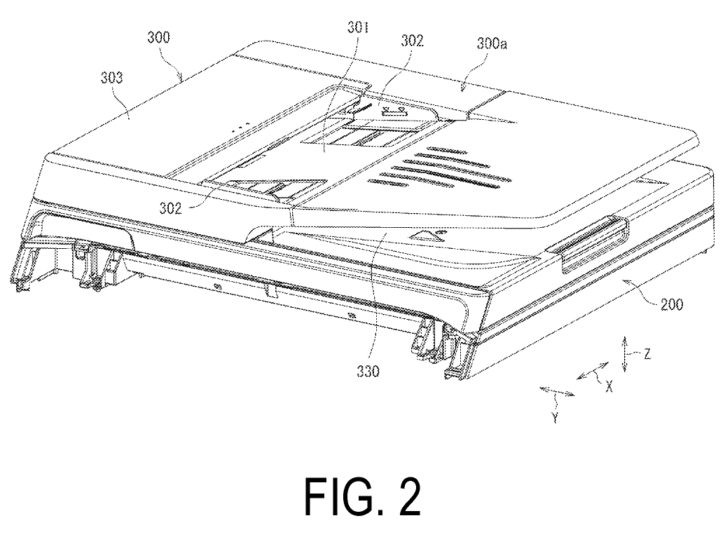

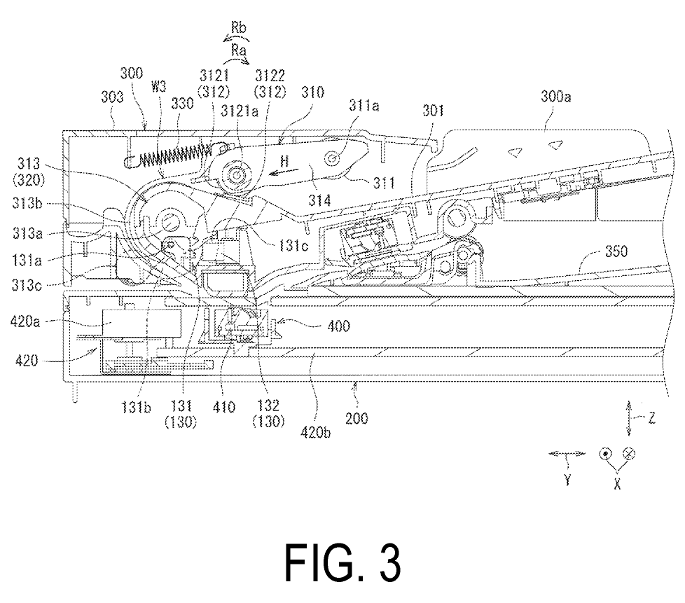

FIG. 2 is a perspective view illustrating the document feeding device 300 and the image reading device 200 illustrated in FIG. 1. FIG. 3 is a cross-sectional view illustrating a main part of the document feeding device 300 and the image reading device 200 illustrated in FIG. 1.

As illustrated in FIGS. 2 and 3, the document feeding device 300 (sheet feeding device) includes a document placement portion 301 (sheet placement portion) on which a plurality of documents G (sheets G) can be placed.

On the document placement portion 301, the plurality of documents G to G can be placed. Therefore, the document placement portion 301 includes a pair of guide members 302 and 302 to align positions of the plurality of documents G in the width direction X, which is a direction orthogonal to the feeding direction (by a feeding roller 311). The guide member 302 may be provided so as to be freely movable (freely slidable) in the width direction X with respect to the document placement portion 301 in order to support the size of the plurality of documents G. In this case, the guide member 302 may be formed to reciprocate in the width direction X with reference to a center in the width direction X of the document G.

The document feeding device 300 further includes a document conveyance path W3 (sheet conveyance path) through which a document G1 placed on the document placement portion 301 is conveyed to the document reading plate portion 222 of the image reading device 200, a document feeder 310 (sheet feeder) that feeds documents placed on the document placement portion 301 to the document conveyance path W3 one by one, a document conveying roller 313 that conveys the document G fed by the document feeder 310 along the document conveyance path W3, a conveyed document detector 130 that detects the document G conveyed by the document conveying roller 313, and a document discharge tray 350 to which the document G read at the document reading plate portion 222 is discharged.

The document feeder 310 includes the feeding roller 311 that sends out the document G (the document G placed on a top when the plurality of documents are placed) placed on the document placement portion 301 toward the document conveyance path W3, and a separation conveyor 312 that prevents the documents G from being fed to the document conveyance path W3 in a state of being vertically overlapped when the plurality of documents G are placed on the document placement portion 301.

The separation conveyor 312 includes a supplying roller 3121 (sheet feeding roller) and a separating member (separating roller or separating pad (separating pad 3122 in this example)) provided so as to abut against the supplying roller 3121, and the feeding roller 311 sends out the document G placed on the document placement portion 301 toward an abutment portion between the supplying roller 3121 and the separating pad 3122. When the documents G sent out by the feeding roller 311 are fed in a vertically overlapped state, the document G on a lower side abuts against the separating pad 3122 at the abutment portion between the supplying roller 3121 and the separating pad 3122, and the document G on an upper side abuts against the rotating supplying roller 3121 at the abutment portion between the supplying roller 3121 and the separating pad 3122. At this time, a rotational force of the supplying roller 3121 is not transmitted to the document G on the lower side because the document G on the upper side is present, and the document G on the lower side is brought into a stopped state by a frictional force received from the separating pad 3122. Therefore, only the document G on the upper side receives the rotational force from the supplying roller 3121, passes through the abutment portion between the supplying roller 3121 and the separating pad 3122, and is fed to the document conveyance path W3. That is, the document feeder 310 feeds the plurality of documents G placed on the document placement portion 301 to the document conveyance path W3 one by one.

Here, the document conveyance path W3 has a shape bent in a U-shape from the document placement portion 301 toward the document discharge tray 350 provided below the document placement portion 301, and is formed such that a lower part of the U-shaped document conveyance path W3 faces the document reading plate portion 222.

The document conveying roller 313 is provided in the document conveyance path W3 on a downstream side relative to the document feeder 310 in a document feeding direction H. In this example, the document conveying roller 313 includes a roller shaft 313a and a plurality of roller portions 313b to 313b provided at the roller shaft 313a at intervals in a rotation axis direction (a direction of a rotation axis α of a rotary shaft 311a) (the width direction X). The document conveying roller 313 is disposed so as to abut against a facing roller 313c, and the document G fed from the document feeder 310 is sandwiched at an abutment portion between the document conveying roller 313 and the facing roller 313c, and is sent out toward the document reading plate portion 222. Then, an image of the document G reaching the document reading plate portion 222 is read by the image sensor 410 of the image scanner 400 moved to the lower side of the document reading plate portion 222, and is converted into electronic data. The document G read by the image sensor 410 of the image scanner 400 is conveyed through the document conveyance path W3 as it is, and is discharged to the document discharge tray 350.

### Conveyed Document Detector

Note that the conveyed document detector 130 (conveyed sheet detector) that detects the document G being conveyed from the document conveying roller 313 is provided at the document conveyance path W3 between the document conveying roller 313 and the document reading plate portion 222.

The conveyed document detector 130 includes a sensed portion 131 that swings when abutting against the document G being conveyed through the document conveyance path W3, and a transmissive optical sensor 132 including a light emitter and a light receiver that receives light from the light emitter. The sensed portion 131 includes a turning shaft 131a that turns about a turning axis along the direction (X) of the rotation axis α of the feeding roller 311, a document abutment arm 131b that is provided at the turning shaft 131a and abuts against the document G, and a sensor light shielding portion 131c that is provided at a turning shaft 341a and is sensed by the transmissive optical sensor 132 (see FIG. 3). The sensed portion 131 is provided such that a part of the document abutment arm 131b is positioned at a position to block the document conveyance path W3 by its own weight in order to detect the document G being conveyed through the document conveyance path W3. In this state, the sensor light shielding portion 131c is located at a position to block a detection optical path (a space between the light emitter and the light receiver) of the transmissive optical sensor 132. Therefore, the light receiver does not receive light from the light emitter, and thus the sensed portion 131 (transmissive optical sensor 132) outputs an output signal Low. Further, when the document G conveyed through the document conveyance path W3 comes into contact with the document abutment arm 131b, the sensed portion 131 is turned about the turning shaft 131a along with the movement of the document G, and the document abutment arm 131b moves to a retracted position to allow the document G to pass. In the state where the document abutment arm 131b is located at the retracted position, the sensor light shielding portion 131c is located at a position where the sensor light shielding portion 131c does not block the detection optical path of the transmissive optical sensor 132. Therefore, while the document abutment arm 131b abuts against the document G being conveyed, that is, while the document abutment arm 131b is located at the retracted position, the sensed portion 131 (the transmissive optical sensor 132) outputs an output signal High. That is, whether the document G is present on the document conveyance path W3 or not can be determined based on whether an output signal is the output signal High or the output signal Low.

Here, the conveyed document detector 130 is provided in a section in the document conveyance path W3 between the document conveying roller 313 and the document reading plate portion 222. Therefore, the timing when the document G reaches the document reading plate portion 222 can be predicted based on an output value of the transmissive optical sensor 132. That is, reading at the document reading plate portion 222 can be started after the conveyed document detector 130 detects the document G, and thus the document G can be read at an appropriate timing.

### Embodiments

### 1. First Embodiment

From here, the document feeding device 300 according to the embodiment will be described in detail.

As described above, the document feeding device 300 (sheet feeding device) includes the document placement portion 301 (sheet placement portion) on which the plurality of documents G (sheets G on which images are formed) can be placed, the document conveyance path W3 (sheet conveyance path) through which the document G is conveyed, the document feeder 310 (sheet feeder) that feeds the document G placed on the document placement portion 301 to the document conveyance path W3, and the conveyed document detector 130 (conveyed sheet detector) that detects the document G being conveyed through the document conveyance path W3.

The document feeder 310 of the embodiment includes the feeding roller 311 that is disposed above the document placement portion 301 and rotates about the rotation axis α by receiving a rotational driving force from a driving source 316, a roller holder 314 that pivotally supports the feeding roller 311, a holder mover 305 that moves the roller holder 314 (by the rotational driving force from the driving source 316) to a lowered position (feeding position) where the feeding roller 311 abuts against the document G placed on the document placement portion 301 or to a raised position where the feeding roller 311 is separated from the document G placed on the document placement portion 301 (or the document placement portion 301 itself when there is no document G), and a document stopper 16 (sheet stopper) that is movable to a first position (regulating position) where feeding of the document G placed on the document placement portion 301 to the document conveyance path W3 is regulated and a second position (non-regulating position) where the feeding of the document G placed on the document placement portion 301 to the document conveyance path W3 is not regulated.

Further, the document feeding device 300 of the disclosure includes an opening/closing member 303 that is movable to an open position to open a part of an upper side of the document conveyance path W3 and a closed position to form the document conveyance path W3, and the opening/closing member 303 is provided with the document feeder 310 and a placed document detector 340 (placed sheet detector) that detects whether the document G is placed on the document placement portion 301 or not.

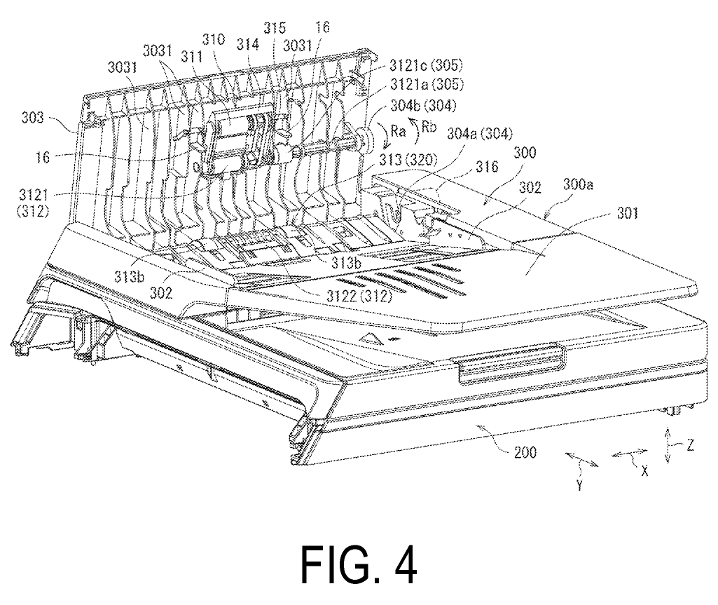

FIG. 4 is a perspective view illustrating a state where the opening/closing member 303 is located at the open position in the document feeding device 300 illustrated in FIG. 1.

As illustrated in FIG. 4, the opening/closing member 303 is supported so as to be freely turnable about a turning axis along a width direction X with respect to a document feeding device main body 300a, and is provided with a plurality of document guide ribs 3031 to 3031 that form a part of the document conveyance path W3 in a state where the opening/closing member 303 is located at the closed position.

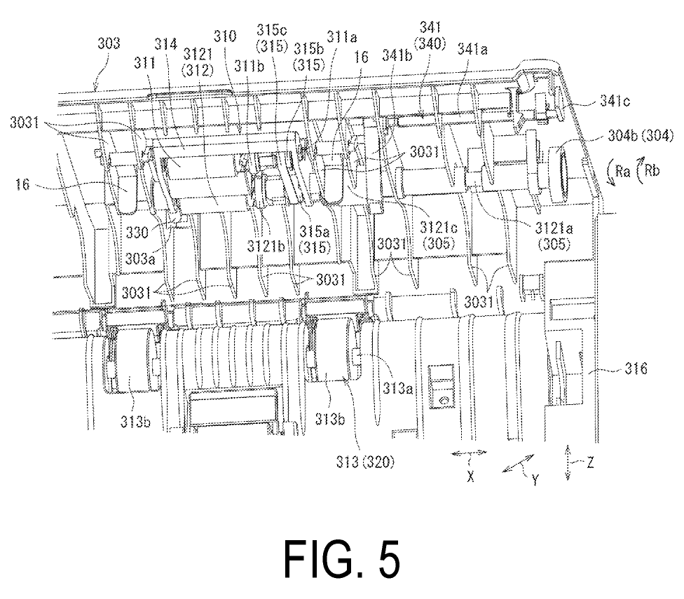

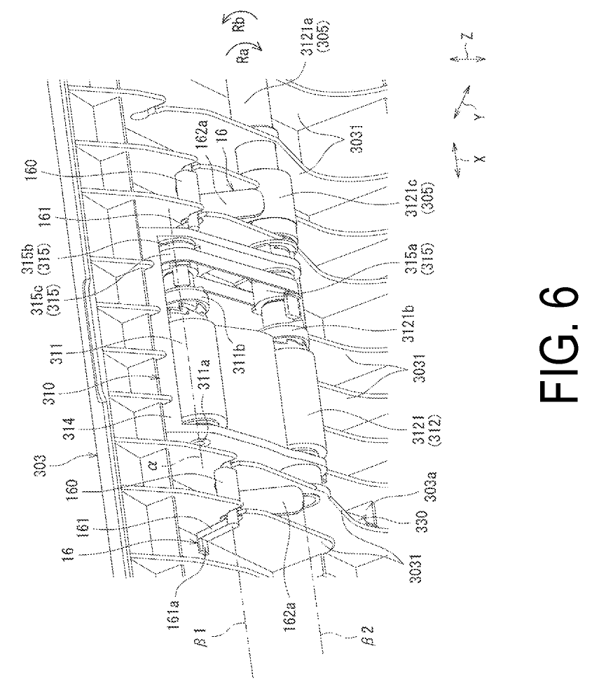

FIG. 5 is a perspective view in which a portion including the document feeder 310 provided at a lower surface of the opening/closing member 303 located at the open position is enlarged and illustrated. FIG. 6 is a perspective view in which a portion including the roller holder 314 at the lower surface of the opening/closing member 303 located at the open position is enlarged and illustrated.

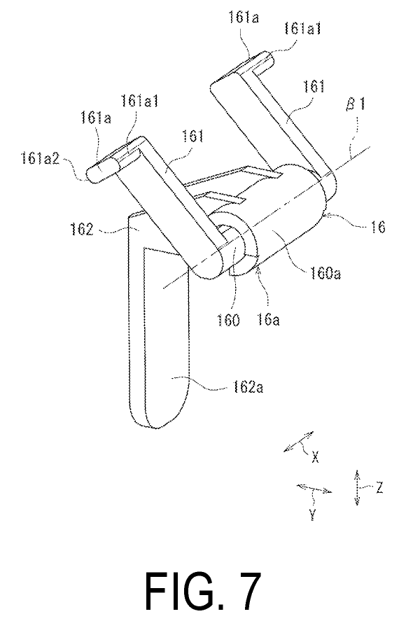

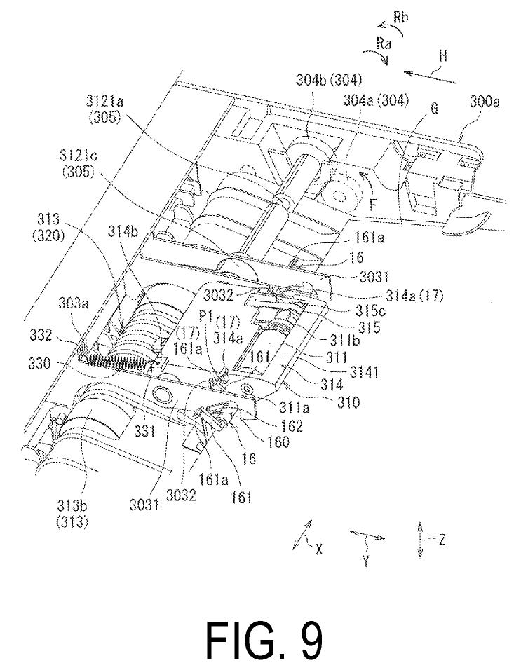

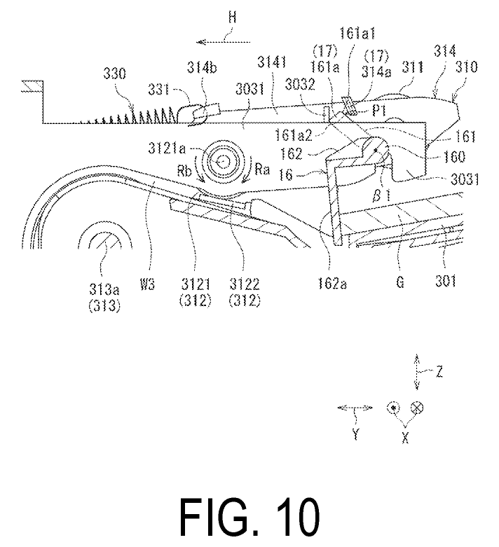

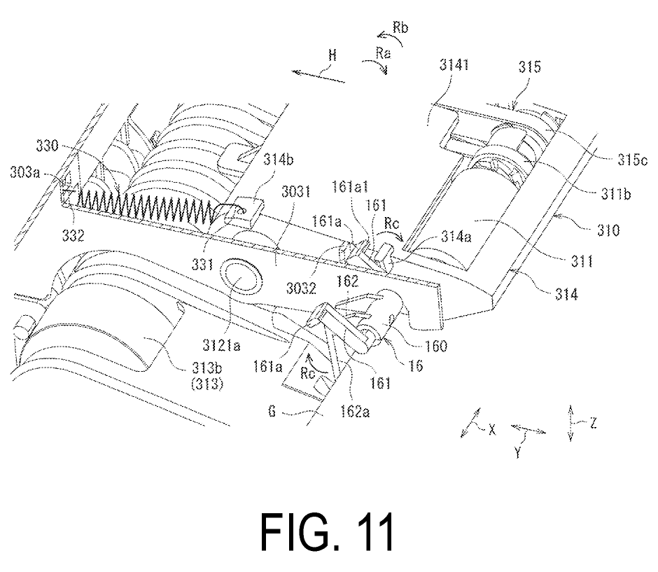

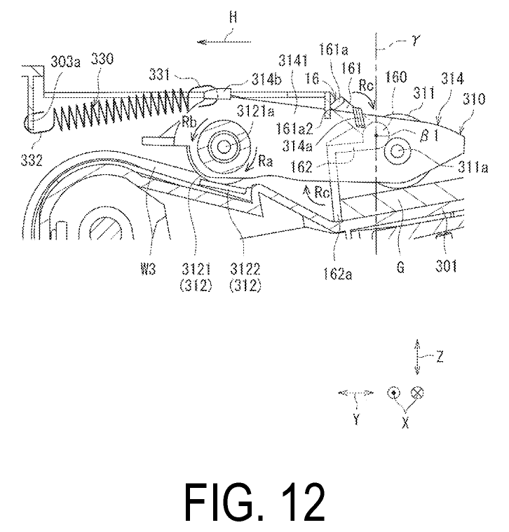

FIG. 7 is a perspective view of the document stopper 16 of the document feeder 310 as viewed obliquely. FIG. 9 is a perspective view in which a portion including the document feeder 310 in a state where the opening/closing member 303 is located at the closed position, the roller holder 314 is located at the raised position, and the document stopper 16 is located at the regulating position, is enlarged and illustrated. FIG. 10 is a diagram of a portion including the document feeder 310 in the state of FIG. 9 (the state where the opening/closing member 303 is located at the closed position, the roller holder 314 is located at the raised position, and the document stopper 16 is located at the regulating position) as viewed from a lateral side, and is a cross-sectional view obtained by being cut at a place of a stopper portion of the document stopper 16. FIG. 11 is a perspective view illustrating a state where the opening/closing member 303 is located at the closed position and the roller holder 314 is located at the lowered position. FIG. 12 is a diagram of the state of FIG. 11 (the state where the opening/closing member 303 is located at the closed position and the roller holder 314 is located at the lowered position) as viewed from a lateral side, and is a cross-sectional view obtained by being cut at a place of an engaging portion 161a of the document stopper 16 and an engaged portion 314a of the roller holder 314.

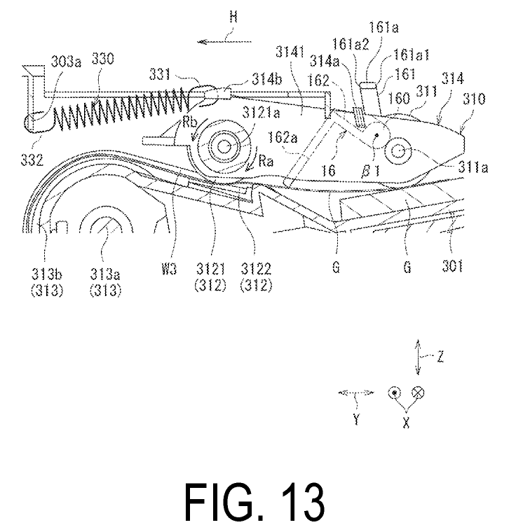

FIG. 13 is a diagram of a portion including the roller holder 314 when the opening/closing member 303 is located at the closed position and document feeding operation is being performed as viewed from a lateral side, and is a cross-sectional view obtained by being cut at the place of the engaging portion 161a of the document stopper 16 and the engaged portion 314a of the roller holder 314.

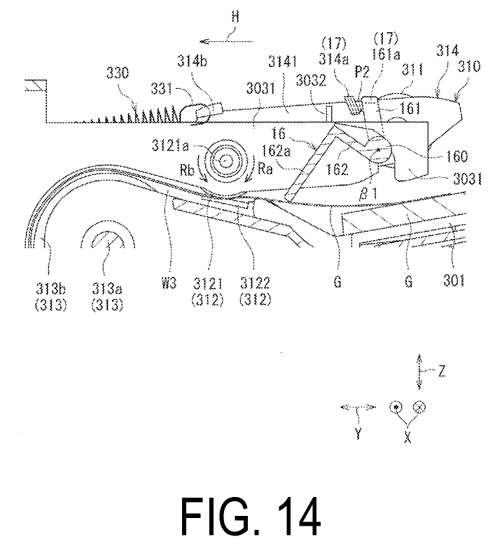

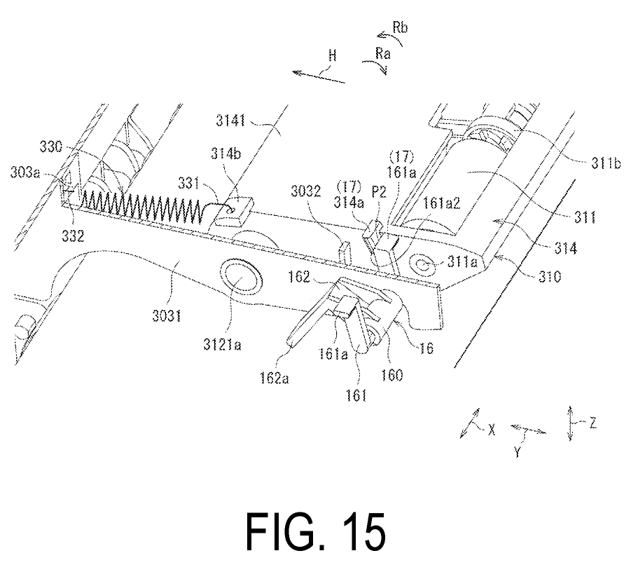

FIG. 14 is a diagram of a state where the roller holder 314 is moved to the raised position when the opening/closing member 303 is located at the closed position and the document G is stopped (jammed) while the document G is being fed to the document conveyance path W3 as viewed from a lateral side, and is a cross-sectional view obtained by being cut at a place of a stopper portion 162a of the document stopper 16. FIG. 15 is a perspective view illustrating the state of FIG. 14 (the state where the roller holder 314 is moved to the raised position when the opening/closing member 303 is located at the closed position and the document G is stopped while the document G is being fed to the document conveyance path W3). Note that in the drawings described above, for the sake of clarity, the opening/closing member 303 in FIGS. 10 to 15 is partially omitted and illustrated.

### Roller Holder

The document feeder 310 is provided above the document placement portion 301, and includes the feeding roller 311 (pickup roller) that rotates by receiving the rotational driving force from the driving source 316 (see FIG. 4), and the roller holder 314 (holding member) that pivotally supports the feeding roller 311.

The feeding roller 311 includes the rotary shaft 311a and is pivotally supported by the roller holder 314 so as to rotate about a rotation axis α of the rotary shaft 311a (see FIG. 6).

### Holder Mover

The document feeder 310 includes the holder mover 305 (raising/lowering mechanism) that moves the roller holder 314 to the lowered position (feeding position) where the feeding roller 311 abuts against the document G placed on the document placement portion 301 or to the raised position where the feeding roller 311 is separated from the document G placed on the document placement portion 301.

The holder mover 305 includes a driving rotary shaft 3121a that rotates by receiving the rotational driving force from the driving source 316, and a torque limiter 3121c (see FIG. 4).

The driving rotary shaft 3121a is provided at the opening/closing member 303 so as to be freely rotatable about a rotation axis parallel to the rotation axis α of the feeding roller 311. The torque limiter 3121c is provided between the driving rotary shaft 3121a and the roller holder 314. In other words, the roller holder 314 is supported via the torque limiter 3121c (torque limiter for raising and lowering the roller holder) so as to be swingable about the driving rotary shaft 3121a. That is, the roller holder 314 is attached to the driving rotary shaft 3121a via the torque limiter 3121c, and is provided so as to swing about a swing axis β2 which is a rotation axis of the driving rotary shaft 3121a. This swing mechanism will be described in detail.

The torque limiter 3121c has a characteristic of not permitting idling until a predetermined load is applied, but permitting idling when the predetermined load is exceeded.

When the driving source 316 rotates in a first direction being a primary direction, the driving rotary shaft 3121a rotates in a forward rotation direction Ra, and thus the roller holder 314 located at the raised position (separated position) illustrated in FIG. 10 rotates (moves) in a direction of the lowered position via the torque limiter 3121c. Then, the feeding roller 311 moves to a position where the feeding roller 311 abuts against the document G placed on the document placement portion 301. Then, when the feeding roller 311 abuts against the document G, the roller holder 314 which is about to rotate via the torque limiter 3121c receives a reactive force from the document G via the feeding roller 311. When a load due to the reactive force exceeds a predetermined value, the torque limiter 3121c idles, and the roller holder 314 stops at the lowered position as illustrated in FIG. 12. That is, the feeding roller 311 is brought into a state of abutting against the document G at a predetermined abutment pressure while the driving rotary shaft 3121b is kept rotating. Here, the driving rotary shaft 3121a and the feeding roller 311 are connected to each other by a timing belt 315c (see FIGS. 5 and 6), and therefore, when the driving rotary shaft 3121a rotates in a forward rotation direction Ra, the feeding roller 311 also rotates in the forward rotation direction Ra about the rotation axis α. Therefore, in a state where the roller holder 314 is moved to the lowered position by the holder mover 305, the document G is sent out toward the document conveyance path W3 by the rotating feeding roller 311. In other words, when the roller holder 314 abuts against the document G on the document placement portion 301 with respect to the rotation of the driving rotary shaft 3121a in the forward rotation direction Ra, swinging of the roller holder 314 is regulated, and a load acting on the torque limiter 3121c exceeds the predetermined load, the driving rotary shaft 3121a can be rotated with respect to the roller holder 314. Therefore, the feeding roller 311 can be rotated via the timing belt 315c, and the document G can be sent out in a document feeding direction H toward the document conveyance path W3. Here, the supplying roller 3121 is provided at the driving rotary shaft 3121a, and the supplying roller 3121 abuts against the separating pad 3122 as described above, and therefore, the documents G sent out from the feeding roller 311 are fed to the document conveyance path W3 one by one by passing between the supplying roller 3121 and the separating pad 3122.

On the other hand, when the driving source 316 rotates in a second direction being a direction opposite to the first direction, and the driving rotary shaft 3121a rotates in a reverse rotation direction Rb, the roller holder 314 located at an abutment position illustrated in FIG. 12 swings (moves) to the raised position (separated position) via the torque limiter 3121c. That is, the roller holder 314 is brought into a state of being separated from the document G or the document placement portion 301. Note that the swinging (movement) of the roller holder 314 from the lowered position to the raised position may be performed by controlling the driving source 316 to rotate by a predetermined angle in the reverse rotation direction Rb and then stopping the driving source 316, or may be performed by controlling the driving source 316 to rotate the driving rotary shaft 3121a in the reverse rotation direction Rb, and stopping the driving source 316 after the torque limiter 3121c idles in a state where the roller holder 314 abuts against the opening/closing member 303 and the rotation of the roller holder 314 is regulated.

As described above, the holder mover 305 can lower the roller holder 314 (the feeding roller 311) by the rotation of the driving rotary shaft 3121a in the forward rotation direction Ra, and on the other hand, can raise the roller holder 314 (feeding roller 311) by the rotation of the driving rotary shaft 3121a in the reverse rotation direction Rb.

Note that, as illustrated in FIGS. 5 and 6, the timing belt 315c that transmits a rotational driving force from the driving rotary shaft 3121a to the feeding roller 311 is an endless belt, and is wound around a driving timing-pulley 315a provided at the driving rotary shaft 3121a and a driven timing-pulley 315b provided at the rotary shaft 311a of the feeding roller 311. Accordingly, the driving rotary shaft 3121a of the supplying roller 3121 is driven to rotate in the forward rotation direction Ra, and thus the rotary shaft 311a of the feeding roller 311 can be rotated in the forward rotation direction Ra, which is the document feeding direction H, via the driving timing-pulley 315a, the timing belt 315c, and the driven timing-pulley 315b.

Note that, although described in detail below, the roller holder 314 is provided with the engaged portion 314a (protruding portion) protruding from the roller holder 314 in the direction of the rotation axis α of the feeding roller 311.

### Document Stopper

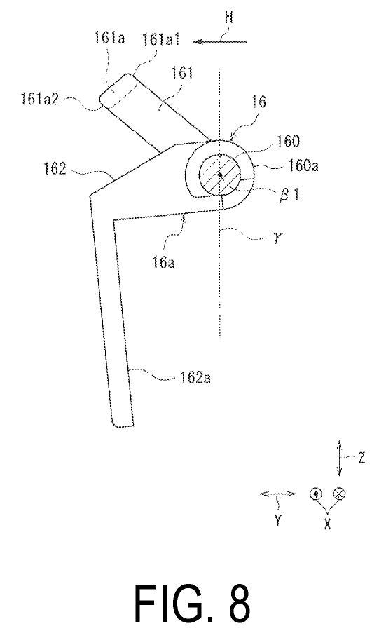

The document feeder 310 further includes the document stopper 16 that regulates movement of the document G placed on the document placement portion 301 in the document feeding direction H. FIG. 7 is a perspective view of the document stopper 16 as viewed obliquely from above. FIG. 8 is a cross-sectional view of the document stopper 16.

As illustrated in FIGS. 7 and 8, the document stopper 16 of the embodiment includes the stopper portion 162a that abuts against a first swing shaft portion 160 and the document G placed on the document placement portion 301, and the engaging portion 161a that can engage with the engaged portion 314a (protruding portion) of the roller holder 314 described above.

The engaging portion 161a of the document stopper 16 is provided on each of one end side and another end side of the first swing shaft portion 160, and the stopper portion 162a is provided at a shaft portion main body 160a which is a main body of the first swing shaft portion 160. In this manner, the engaging portion 161a and the stopper portion 162a are fixed to the first swing shaft portion 160 at different positions in a circumferential direction.

The document stopper 16 further includes a first arm portion 161 and a second arm portion 162. The first arm portions 161 are fixed to one end and another end of the first swing shaft portion 160, and the second arm portion 162 is fixed to the shaft portion main body 160a. Further, the first arm portion 161 and the second arm portion 162 are provided at different positions about a first swing axis β1, which is the rotation axis of the shaft portion. Further, the first arm portion 161 and the second arm portion 162 are provided on the same side with respect to a virtual vertical line γ passing through the first swing axis β1 which is a center line of the first swing shaft portion 160 and intersecting with the document feeding direction H of the document G, specifically, on a downstream side in the document feeding direction H. Then, the engaging portion 161a and the stopper portion 162a are provided at a tip end portion of the first arm portion 161 and a tip end portion of the second arm portion 162, respectively. The engaging portion 161a is an engaging protruding portion protruding to an opposite side of the shaft portion main body 160a at the tip end portion of the first arm portion 161, and a first engaging portion 161a1 is provided at an end on an upstream side in the document feeding direction H of the engaging protruding portion, and a second engaging portion 161a2 is provided at an end on the downstream side in the document feeding direction H. The stopper portion 162a is formed at the tip end portion of the second arm portion 162 so as to extend to an opposite side of the engaging portion 161a, and includes a flat surface portion extending in a direction of the first swing axis β1 at a portion formed so as to extend from the tip end portion of the second arm portion 162.

As described above, the document stopper 16 includes the engaging portion 161a, the stopper portion 162a that abuts against the document G placed on the document placement portion 301, and the first swing shaft portion 160 that turns about the first swing axis β1 along the direction of the rotation axis α of the feeding roller 311, the engaging portion 161a and the stopper portion 162b are provided at the different positions in the circumferential direction of the first swing shaft portion 160, and the stopper portion 162b includes the flat surface portion that abuts against one ends of the plurality of documents G placed on the document placement portion 301 and aligns end positions of the plurality of documents G.

Further, the document stopper 16 includes the first arm portion 161 extending from the first swing shaft portion 160 in a radial direction of the first swing shaft portion 160 and the second arm portion 162 extending from a peripheral surface of the first swing shaft portion 160 where the first arm portion 161 is not provided in the radial direction of the first swing shaft portion 160, the engaging portion 161a is the engaging protruding portion provided so as to protrude toward the roller holder 314 side at the tip end portion of the first arm portion 161, the flat surface portion included in the stopper portion 162a is provided so as to extend from the tip end portion of the second arm portion 162 to the side opposite to the engaging portion 161a in a direction intersecting with an extending direction of the second arm portion 162, and the first arm portion 161 and the second arm portion 162 are located on the downstream side in the feeding direction of the document G with respect to the virtual vertical line passing through the first swing axis β1 in a state where the document stopper 16 is located at the regulating position (first position). Therefore, a center of gravity of the document stopper 16 is on a downstream side in the document feeding direction H relative to the virtual vertical line γ. As a result, the force to rotate counterclockwise about the first swing axis β1 from a position of the document stopper 16 illustrated in FIG. 8 acts on the document stopper 16. An effect of this formation will be described below.

As illustrated in FIGS. 4 to 6, the document stopper 16 (the first swing shaft portion 160 thereof) having the above-described formation is supported by (some of) the plurality of document guide ribs 3031 to 3031 of the opening/closing member 303 such that the first swing shaft portion 160 is turnable. Here, the document stopper 16 and the roller holder 314 are provided (at the opening/closing member 303) so as to be adjacent to each other in the direction of the rotation axis α of the feeding roller 311, and the first swing axis β1, which is an axis direction of the first swing shaft portion 160 of the document stopper 16, is provided (at the opening/closing member 303) so as to be parallel to the rotation axis α of the feeding roller 311. As described above, the first swing shaft portion 160 of the document stopper 16 is provided at the opening/closing member 303 so as to be freely swingable about the first swing axis β1 along the direction (X) of the rotation axis α of the feeding roller 311.

As described above, the opening/closing member 303 includes the plurality of document guide ribs 3031 that form a part of the document conveyance path W3 and extend along the feeding direction H of the document G, the document stopper 16 is supported between the plurality of document guide ribs 3031 so as to be swingable about the first swing axis β1, and the roller holder 314 described above is provided at the document guide ribs 3031 so as to be freely swingable about the second swing axis β2 along the direction of the rotation axis α of the feeding roller 311.

As described above, the first swing shaft portion 160 is supported by the opening/closing member 303 so as to be freely swingable, and thus, although details will be described below, in the state where the opening/closing member 303 is located at the closed position and the roller holder 314 is located at the lowered position, the document stopper 16 can rotate and move (swing) between the regulating position (first position) where the stopper portion 162a regulates the movement (feeding) of the document G placed on the document placement portion 301 to the document conveyance path W3 and the non-regulating position (second position) where the movement (feeding) of the document G placed on the document placement portion 301 to the document conveyance path W3 is not regulated.

Further, as illustrated in FIGS. 4 to 6, the document stoppers 16 are provided at the opening/closing member 303 on both outer sides in the rotation axis direction (X) of the roller holder 314. That is, the two document stoppers 16 are disposed at the opening/closing member 303 so as to be line-symmetrical with respect to the roller holder 314 with reference to a reference line along an up-down direction Z as viewed from one side in a left-right direction Y. As described above, the engaging portion 161a of the document stopper 16 is provided at each of the one end side and the other end side of the first swing shaft portion 160. Therefore, the document stoppers 16 and 16 disposed with the roller holder 314 interposed therebetween in the direction of the rotation axis α of the feeding roller 311 include the engaging portions 161a and 161a facing the roller holder 314 side. Thus, a pair of the document stoppers 16 and 16 can be made common components.

### Holding Regulating Portion

As described above, the document stopper 16 is formed to be swingable between the regulating position (first position) where the movement of the document to the document conveyance path W3 is regulated and the non-regulating position (second position) where the movement of the document to the document conveyance path W3 is not regulated, and is provided at the opening/closing member 303, but the document feeder 310 of the embodiment further includes a holding regulating portion 17 that holds the position of the document stopper 16, that is, the regulating position or the non-regulating position to regulate swinging. The holding regulating portion 17 includes the engaged portion 314a provided at the roller holder 314 and the engaging portion 161a provided at the document stopper 16.

Next, the operation of this holding regulating portion 17 will be described.

### Regulating Position (First Position)

FIG. 9 is a perspective view in which the document feeder 310 when the document stopper 16 is located at the regulating position in a state where the roller holder 314 is located at the raised position is enlarged and illustrated. FIG. 10 is a cross-sectional view in which the state of FIG. 9, that is, the document feeder 310 when the document stopper 16 is located at the regulating position in the state where the roller holder 314 is located at the raised position, is cut at a place of the stopper portion 162a of the document stopper 16 and illustrated.

As illustrated in FIGS. 9 and 10, in a state where the roller holder 314 is located at the raised position and the document stopper 16 is located at the regulating position, even when the document stopper 16 is about to rotate about the first swing axis β1, the engaging portion 161a of the document stopper 16 (the second engaging portion 161a1 thereof) engages with (abuts against) the engaged portion 314a of the roller holder, and thus, swinging of the stopper portion 162a to the downstream side in the document feeding direction H is regulated. Additionally, a rotation stopping portion 3032 that regulates rotation of the document stopper 16 is provided at the document guide rib 3031 of the opening/closing member 303 that supports the document stopper 16. That is, the rotation stopping portion 3032 that regulates swinging of the stopper portion 162a of the document stopper 16 located at the regulating position to the upstream side in the feeding direction H of the document G is provided at the document guide rib 3031. Therefore, even when the document stopper 16 is about to rotate about the first swing axis β1, the rotation stopping portion 3032 abuts against the engaging portion 161a (the second engaging portion 121a2 thereof), so that swinging of the stopper portion 162a to the upstream side in the document feeding direction H is regulated. That is, rotation of the engaging portion 161a is regulated by the rotation stopping portion 3032 and the engaged portion 314a of the roller holder 314 located at the raised position, and therefore, movement from the regulating position is regulated. That is, the engaging portion 161a is held at the regulating position. This state where the roller holder 314 is located at the raised position and the movement of the document stopper 16 from the regulating position is regulated by the holding regulating portion 17, that is, a state where the document stopper 16 is held at the regulating position is referred to as a feeding preparation state.

In the feeding preparation state where the document stopper 16 is held at the regulating position by the holding regulating portion 17 as described above, the document G on the document placement portion 301 abuts against the document stopper 16, and thus movement of the document G in the document feeding direction H is regulated, so that the plurality of documents G can be placed on the document placement portion 301 in a state where end portions thereof are aligned. That is, since the plurality of documents G are placed on the document placement portion 301 in a state where positions thereof are aligned (feeding directions of the feeding roller 311 with respect to the plurality of documents G are aligned), a feeding condition by the feeding roller 311 is stabilized, and occurrence of conveyance failure can be suppressed.

### Non-regulating Position (Second Position)

Next, the operation of the document stopper 16 in a state where the roller holder 314 is located at the lowered position will be described.

FIG. 11 is a perspective view in which the document feeder 310 when the document stopper 16 is located at the regulating position in the state where the roller holder 314 is located at the lowered position is enlarged and illustrated. FIG. 12 is a cross-sectional view in which the state of FIG. 11, that is, the document feeder 310 when the document stopper 16 is located at the regulating position in the state where the roller holder 314 is located at the lowered position, is cut at a place of the stopper portion 162a of the document stopper 16 and illustrated.

As illustrated in FIGS. 11 and 12, when the roller holder 314 is moved to the lowered position by the holder mover 305, the engaged portion 314a provided at the roller holder 314 also moves downward, and moves to a position where the engaged portion 314a is not engaged with the engaging portion 161a (not on a moving path of the engaging portion 161a). Therefore, the document stopper 16 at the regulating position is rotatable in a direction Rc about the first swing axis β1. Then, when the roller holder 314 is located at the lowered position and the feeding roller 311 abutting against the document G placed on the document placement portion 301 feeds the abutting document G in the document feeding direction H, the document G to be fed pushes up the stopper portion 162a, and the document stopper 16 turns to the non-regulating position where the document stopper 16 does not regulate passage of the document G. FIG. 13 is a diagram that explains this state, and is a cross-sectional view illustrating the state where the document G being fed pushes up the stopper portion 162a and the document stopper 16 is located at the non-regulating position. As illustrated in FIG. 13, since the engaged portion 314a is located at a position lower than the engaging portion 161a, the document stopper 16 can move to the non-regulating position while rotation is not regulated by the engaged portion 314a.

As described above, the document stopper 16 and the roller holder 314 are provided so as to be adjacent to each other in the direction of the rotation axis α of the feeding roller 311, the holding regulating portion 17 includes the engaged portion 314a provided at the roller holder 314 and the engaging portion 161a provided at the document stopper 16 and engageable with the engaged portion 314a, the engaged portion 314a is an engaged protruding portion protruding from the roller holder 314 toward the document stopper 16 side, is located at the position so as not to be engaged with the engaging portion 161a in the state where the roller holder 314 is located at the lowered position, and is located at the position so as to be engaged with the engaging portion 161a in the state where the roller holder 314 is located at the raised position.

In the state where the roller holder 314 is located at the lowered position, the documents G fed from the feeding roller 311 are separated one by one when passing through the abutment portion between the supplying roller 3121 and the separating pad 3122 as described above and are fed to the document conveyance path W3. Then, the document G fed to the document conveyance path W3 is sent toward the document reading plate portion 222 by the document conveying roller 313 that rotates by receiving the rotational driving force of the driving source 316, is read by the image sensor 410 of the document reading device 400, and the read document G is discharged to the document discharge tray 350.

Next, the operation of the holding regulating portion 17 when the document G being conveyed in the document conveyance path W3 is stopped in the middle for some reason without being discharged to the document discharge tray 350, that is, when the document G is jammed will be described.

### Operation of Holding Regulating Portion in Case of Jam (Retracting Operation)

As described above, the conveyed document detector 130 (conveyed sheet detector) is provided between the document conveying roller 313 and the document reading plate portion 222 in the document conveyance path W3. Therefore, when the conveyed document detector 130 outputs the output signal High for a predetermined time or more, or when the output signal does not become High even after a predetermined time is elapsed since the feeding roller 313 starts feeding the document G, it can be determined that the document G is stopped in the document conveyance path W3. In such a case, after the rotation of the driving source 316 rotated in the first direction is stopped, a retracting operation (retracting processing) is performed to rotate the driving source 316 in the second direction opposite to the first direction and move the roller holder 314 to the raised position (separated position).

FIGS. 14 and 15 illustrate a state where the retracting operation is performed in a state where the document stopper 16 is located at the non-regulating position, that is, in a state where the stopped document G pushes up the stopper portion 162a. FIG. 14 is a cross-sectional view in which the document feeder 310 in a state where the document stopper 16 is located at the non-regulating position and the roller holder 314 is located at the raised position is cut at a place of the stopper portion 162a of the document stopper 16 and illustrated. FIG. 15 is similar to FIG. 14, that is, a perspective view in which the document feeder 310 in the state where the document stopper 16 is located at the non-regulating position and the roller holder 314 is located at the raised position is enlarged and illustrated.

As illustrated in FIGS. 14 and 15, in the state where the document stopper 16 is located at the non-regulating position and the roller holder 314 is located at the raised position, even when the document stopper 16 is about to rotate about the first swing axis β1, the engaging portion 161a of the document stopper 16 engages with (abuts against) the engaged portion 314a of the roller holder, and thus, swinging of the stopper portion 162a to the upstream side in the document feeding direction H is regulated. That is, the document stopper 16 is held at the non-regulating position by the holding regulating portion 17. Therefore, even when the document G stopped in the document conveyance path W3 is pulled out by holding an end portion of the document G on the document placement portion 301 side, it is possible to prevent the stopper portion 162a from rotating and damaging the document G being pulled out.

### Drive Transmitter and Biasing Member

The document feeding device 300 according to the embodiment includes a drive transmitter 304 that transmits the rotational driving force of the driving source 316 to the driving rotary shaft 3121a. The drive transmitter 304 includes a drive gear 304a that is connected to a gear provided at the rotary shaft of the driving source 316 provided at the document feeding device main body 300a by a gear train or the like and rotates when the driving source 316 rotates, and a rotary shaft gear 304b provided at an end portion of the driving rotary shaft 3121a on a side opposite to a side where the supplying roller 3121 is provided.

The driving rotary shaft 3121a is pivotally supported by the opening/closing member 303 as described above (specifically, pivotally supported by a bearing (not illustrated) provided at the document guide rib 3131), and the rotary shaft gear 304b is formed to mesh with the drive gear 304a in the state where the opening/closing member 303 is located at the closed position and to be separated from the drive gear 304a in the state where the opening/closing member 303 is located at the open position. Therefore, in the state where the opening/closing member 303 is located at the closed position, the driving rotary shaft 3121a can receive the rotational driving force from the driving source 316 and rotate in any direction of the directions of Ra, which is the direction to move the roller holder 314 to the lowered position, or the direction Rb to move the roller holder 314 to the raised position, but in the state where the opening/closing member 303 is located at the open position, the rotary shaft gear 304b does not mesh with the drive gear 304a and can therefore rotate freely. Therefore, even in the state where the roller holder 314 is moved to the raised position by the retracting operation, when the opening/closing member 303 is opened, the roller holder 314 is moved by its own weight to the lowered position where the engaged portion 314a provided at the roller holder 314 is not engaged with the engaging portion 161a of the document stopper 16. Therefore, the document feeding device 300 of the embodiment is provided with a biasing member 330 (in this example, a coil spring) that applies a biasing force in a direction in which the roller holder 314 is rotated toward the raised position side.

One end of the biasing member 330 is locked to a locking portion 303a (locking portion 1) provided between the document guide rib 3031 of the opening/closing member 303, and another end is locked to a locking portion 314b (locking portion 2) provided at the roller holder 314. It is sufficient that the biasing force of the biasing member 330 is force enough to be capable of holding the roller holder 314 at the raised position in the state where the opening/closing member 303 is located at the open position, that is, in a state where the rotary shaft gear 304b is separated from and not engaged with the drive gear 304a, and the biasing force does not have force enough to prevent the roller holder 314 from moving to the lowered position when the opening/closing member 303 is located at the closed position and the rotational driving force is transmitted from the driving source 316. Further, in a state where the opening/closing member 303 is located at the closed position and the roller holder 314 is located at the lowered position, the biasing force is not strong enough to move the roller holder 314 to the raised position.

With this formation, in a state where the document G is stopped for some reason during feeding of the document G and the retracting operation is performed, even when the opening/closing member 303 is moved to the open position to remove the stopped document G and then the opening/closing member 303 is erroneously returned to the closed position before the document G is removed, the document G remaining on the document placement portion 301 can be prevented from being damaged because the document stopper 16 is held at the non-regulating position.

Note that in order to facilitate the pulling out of the document G stopped on the document placement portion 301 during the feeding in the state where the opening/closing member 303 is located at the closed position, a torque limiter may be separately provided between the rotary shaft gear 304b and the driving rotary shaft 3121a. In this way, the document G can be taken out without opening the opening/closing member 303. Even at this time, since the document stopper 16 is held at a retracted position, the document to be pulled out is prevented from being damaged by the document stopper 16.

Further, although described in detail below, a clutch device (not illustrated) is provided between the driving source 316 and the drive gear 304a, and by controlling the clutch device, it is possible to switch between a state where the rotational driving force is transmitted from the rotating driving source 316 to the drive gear 304a and a state where the rotational driving force is not transmitted. This makes it possible to create a state where the document conveying roller 313 is rotating by receiving the rotational driving force from the driving source 316 but the feeding roller 311 is stopped.

### Placed Document Detector

The document feeding device 300 of the embodiment further includes the placed document detector 340 (placed sheet detector) that detects whether the document G is placed on the document placement portion 301 or not.

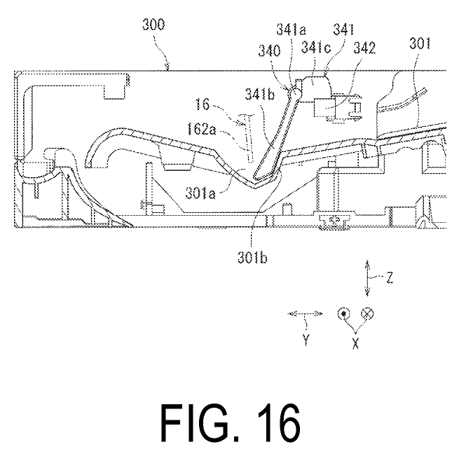

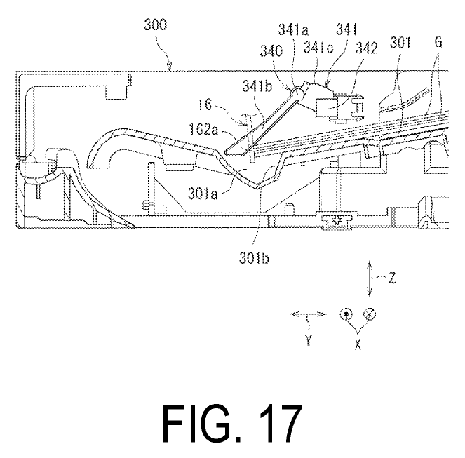

FIGS. 16 and 17 are cross-sectional views of a document detection state of the placed document detector 340 as viewed from a lateral side, FIG. 16 illustrates a state where the document G is not placed on the document placement portion 301, and FIG. 17 illustrates a state where the document G is placed on the document placement portion 301.

As illustrated in FIGS. 4, 16, and 17, the placed document detector 340 is provided at the opening/closing member 303 so as to be located above the document placement portion 301.

The placed document detector 340 includes a detected portion 341 that changes in position depending on presence or absence of the document G, and a transmissive optical sensor 342 in which a light emitter and a light receiver that receives light from the light emitter (not illustrated) are disposed with a predetermined gap therebetween. The detected portion 341 includes the turning shaft 341a that turns about a turning axis along the direction (X) of the rotation axis α of the feeding roller 311, a document abutment arm 341b that is provided so as to protrude from one end of the turning shaft 341a in a radial direction of the turning shaft 341a and abuts against the document G placed on the document placement portion 301, and a sensor light shielding portion 341c that is provided so as to protrude from another end of the turning shaft 341a in the radial direction of the turning shaft 341a and is detected by the transmissive optical sensor 342. Here, "rotation" refers to movement of a target member by 360 degrees or more, whereas "turning" refers to movement of the target member by less than 360 degrees.

As illustrated in FIG. 16, in the state where the document G is not placed on the document placement portion 301, the detected portion 341 turns about the turning shaft 341a by the document abutment arm 341b's own weight, and the document abutment arm 341b is brought into a state of abutting against a wall portion 301b of a recessed portion 301a provided at a bottom portion of the document placement portion 301 and being stopped. In this state, the sensor light shielding portion 341c provided at the detected portion 341 is located at a position so as not to block a detection optical path formed in a gap between the light emitter and the light receiver of the transmissive optical sensor 342. Therefore, the transmissive optical sensor 342 outputs the output signal High when the light receiver receives light from the light emitter. When the document G is placed on the document placement portion 301 from this state so that a tip end portion thereof abuts against the stopper portion 162a of the document stopper 16, as illustrated in FIG. 17, the document abutment arm 341b abuts against the tip end portion of the placed document G and turns the detected portion 341 about the turning shaft 341a. In this state, the sensor light shielding portion 341c is located at a position to block the detection optical path of the transmissive optical sensor 342. Therefore, the transmissive optical sensor 342 outputs the output signal Low because the light receiver cannot receive light from the light emitter.

As described above, the placed document detector 340 outputs the output signal High in the state where the document G is not placed on the document placement portion 301, and outputs the output signal Low in the state where the document G is placed on the document placement portion 301. That is, it is possible to determine whether the document G is present on the document placement portion 301 or not depending on whether the output signal is the output signal High or the output signal Low.

### End Operation (Feeding Preparation State)

The document feeding device 300 according to the embodiment stops the driving source 316 at a time point when the placed document detector 340 detects that there is no document G at timing when a predetermined time elapses after the conveyed document detector 130 detects the output signal Low indicating the state where the document G is not detected during the feeding operation of the document G by the document feeder 310. At this time, since there is no document G on the document placement portion 301, the document stopper 16 rotates about the first swing axis β1 by its own weight as described above, and the second engaging portion 161a2 of the engaging portion 161a abuts against the rotation stopping portion 3032 provided at the opening/closing member 303 and stops. That is, the document stopper 16 is in a state of being located at the regulating position. After this state is reached, the driving source 316 is rotated in the second direction to move the roller holder 314 to the raised position, the engaged portion 314a of the roller holder 314 engages with (abuts against) the first engaging portion 161a1 of the engaging portion 161a, the feeding preparation state where the document stopper 16 is held at the regulating position is reached, and then end operation of ending the feeding operation of the document G is performed. That is, the feeding operation of the document G is ended after creating a state where the document G may be placed on the document placement portion 301.

### Operation Display and Controller

The image reading device 200 including the document feeding device 300 according to the embodiment further includes an operation display 120 (operation panel) and a controller 15.

The operation display 120 is provided on a near side (front side of the image forming apparatus 100) in the width direction X with respect to the image reading device 200 included in the image forming apparatus body 110, although not illustrated. The operation display 120 displays various types of information based on display information (display data) sent from the controller 15. Further, the operation display 120 includes an operation inputter that receives an operation from a user (operator), and the controller 15 can cause the image reading device 200 and the document feeding device 300 to perform a predetermined operation based on the operation (operation information) received by the operation inputter.

### Controller

Here, the controller 15 that controls the document feeding device 300 and the document reading device 200 will be described.

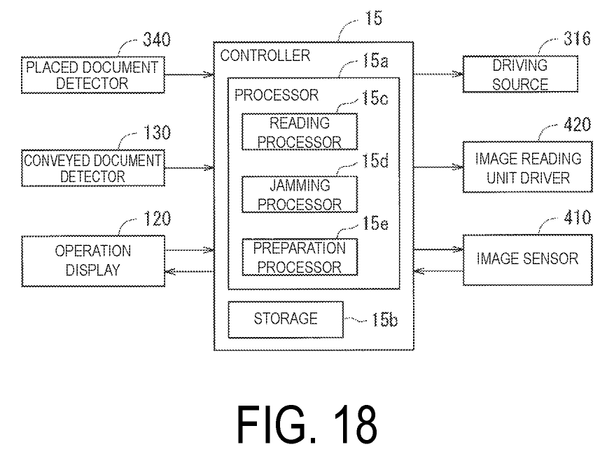

FIG. 18 is a schematic block diagram illustrating a system formation of the controller 15, the document feeding device 300, and the image reading device 200 controlled by the controller 15.

The image reading unit driver 420 of the image reading device 200 is connected to an output system of the controller 15, and is driven based on a driving signal from the controller 15. The image sensor 410 of the image reading device 200 is connected to the output system and an input system of the controller 15, reading is started based on a driving signal from the controller 15, and an image signal read by the image sensor 410 is received.

The driving source 316 of the document feeding device 300 is connected to the output system of the controller 15 and is driven based on a driving signal from the controller 15. The placed document detector 340 (transmissive optical sensor 342) of the document feeding device 300 is connected to the input system of the controller 15, and transmits different output signals to the controller 15 depending on whether the document G is placed on the document placement portion 301 or not. The conveyed document detector 130 (transmissive optical sensor 132) provided at the document conveyance path W3 of the document feeding device 300 is connected to the input system of the controller 15, and transmits different output signals to the controller 15 depending on whether the document G is detected or not.

The operation display 120 is connected to the output system of the controller 15 and receives display information from the controller 15. That is, the operation display 120 can receive and display the display information from the controller 15. Also, the operation display 120 is connected to the input system of the controller 15, and transmits an input operation from a user to the controller 15 as operation information. Accordingly, the controller 15 can recognize the operation information of the user and perform processing corresponding to the operation information.

The controller 15 includes a processor 15a including a microcomputer such as a CPU, and a storage 15b including a nonvolatile memory such as a ROM and a volatile memory such as a RAM. The processor 15a loads a control program stored in advance in the ROM of the storage 15b onto the RAM of the storage 15b and executes the control program, so that the controller 15 performs operation control (processing) of various components.

The processor 15a includes a plurality of operation control processors that are executed by the loaded control program. The processor 15a includes a reading processor 15c, a jamming processor 15d, and a preparation processor 15e.

The reading processor 15c can perform, for example, first reading processing of driving the image reading unit driver 420 to scan the image scanner 400 in the left-right direction Y, reading the document G placed on the document table 221 by the image sensor 410, and performing conversion into electronic data, or second reading processing of driving the document feeder 310 and the document conveying roller 313 by the driving source 316 to convey the document G placed on the document placement portion 301 to the document reading plate portion 222, reading the document G by the image sensor 410, and performing conversion into electronic data, and selectively performs and processes either processing based on operation information received by the operation display 120.

The reading processor 15c can determine whether the document G being conveyed through the document conveyance path W3 is jammed or not based on an output signal from the conveyed document detector 130 during the second reading processing, and when determining that the document G is jammed, the jamming processor 15d performs the retracting processing of performing retracting operation of moving the roller holder 314 to the raised position.

After the jamming processor 15d performs the retracting processing, the preparation processor 15e performs a preparation operation (preparation processing) of moving the roller holder 314 located at the raised position to the lowered position and then moving the roller holder to the raised position again, based on operation information received by the placed document detector 340 or the operation display 120.

Note that the controller 15 can determine whether the document G is placed on the document placement portion 301 or not based on an output signal from the placed document detector 340. Therefore, in a state where the placed document detector 340 does not detect the document G, the second reading processing by the reading processor 15c is not performed even when the operator operates the operation display 120.

### Control Flow

Here, a flow in which the controller 15 performs the second reading processing that is the processing of reading the document G using the document feeding device 300 will be described.

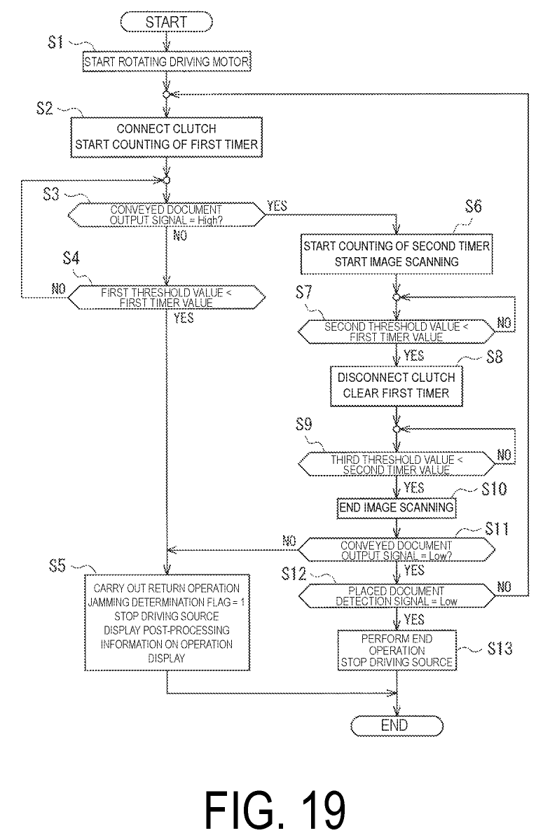

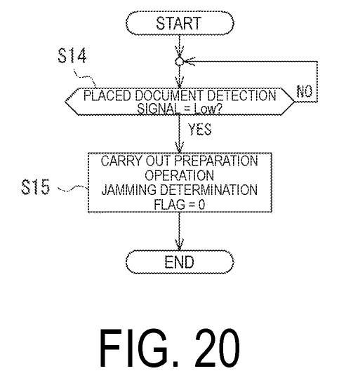

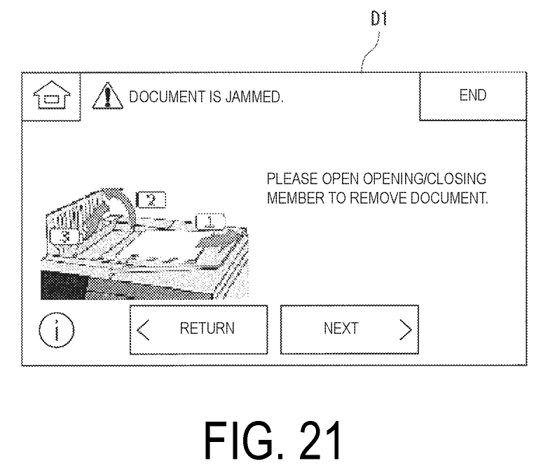

FIG. 19 is a flowchart illustrating the flow of the second reading processing performed by the controller 15. FIG. 20 is a flow of return operation (return processing) performed by the controller 15 after the document G is stopped during the second reading processing, and the retracting operation is performed. FIG. 21 is an example of post-processing information (first display screen D1) to prompt removal of the document G displayed on the operation display 120 when the retracting operation is performed.

When receiving operation information to perform the second reading processing from the operation display 120, the controller 15 starts performing the second reading processing and carries out step S1.

In step S1, the driving source 316 is rotated in a first rotation direction being a predetermined primary direction. Then, the processing proceeds to the next step S2.

In step S2, the clutch device is operated to transmit the driving rotational force of the driving source 316 to the holder mover 305 (clutch connection), to move the roller holder 314 to the lowered position, and cause the feeding roller 311 to abut against the document G placed on the document placement portion 301. Then, the document G is sent out to the document conveyance path W3, and at the same time, counting of a first timer being a primary timer is started, and the processing proceeds to the next step S3.

In step S3, the conveyed document detector 130 determines whether the output signal High is output or not, and when it is determined that the output signal High is not detected, the processing proceeds to step S4, and when the output signal High is detected, the processing proceeds to step S6. Next, a flow after the processing proceeds to step S4 will be described first, and step S6 and subsequent processing will be described below.

In step S4, it is determined whether the first timer reaches a first threshold value being a predetermined time or not. When the first threshold value is not reached, the processing returns to step S3 again, and when the first threshold value is reached, the processing proceeds to step S5.

In step S5, since a conveyed document output signal is not High although a value of the first timer reaches the first threshold value, that is, the document G for which feeding is started is not in a state of reaching the conveyed document detector 130, the retracting operation is performed, and the post-processing information (refer to FIG. 21) to prompt removal of the document G stopped in the document conveyance path W3 is displayed on the operation display 120, and then the second reading processing is ended. As described above, the retracting operation refers to the operation of stopping the driving source 316, rotating the driving source 316 in the second rotation direction opposite to the first rotation direction to move the roller holder 314 to the raised position, and then stopping the driving source 316. Accordingly, when the document stopper 16 is in a state of being located at the second position (non-regulating position) due to the stopped document G, the document stopper 16 is brought into a state of being held at the second position by the holding regulating portion 17. In other words, the engaging portion 161a of the document stopper 16 is brought into a state of being engaged with the engaged portion 314a of the roller holder 314 at a second engaging position P2 (state of being engaged at the second engaging position P2). Therefore, even when the opening/closing member 303 is opened and closed, the document G stopped by the document stopper 16 can be prevented from being damaged. Then, a value of a jamming determination flag that is a flag to check that the retracting operation is performed and is a flag to determine a jammed state, is set to 1.

Next, step S6 to which the processing proceeds when the processing returns to step S3 and in which the conveyed document detector 130 outputs the output signal High will be described.

In step S6, reading of the document G by the image sensor 410 of the image reading device 200 is started, counting of a second timer being a secondary timer is started, and then the processing proceeds to the next step S7.

In step S7, it is determined whether the value of the first timer reaches a second threshold value being a secondary threshold value or not, and first delay processing of waiting until the value of the first timer reaches the second threshold value is performed. Here, the second threshold value is a time of timing when a trailing edge of the document G is separated from the feeding roller 311. Therefore, step S7 is processing of waiting for a time. Then, when the value of the first timer reaches the second threshold value, the processing proceeds to the next step S8.

In step S8, the clutch device is brought into a state of not transmitting a driving rotational force (clutch disconnected state), so that the rotation of the feeding roller 311 is stopped and the next document G is not fed to the document conveyance path W3. Then, the first timer is cleared and the processing proceeds to the next step S9.

In step S9, it is determined whether a value of the second timer reaches a third threshold value being a tertiary threshold value or not, and second delay processing of waiting until the value of the second timer reaches the third threshold value is performed. Here, the third threshold value is a time period from when the trailing edge of the document G passes through the conveyed document detector 130 to when the trailing edge of the document G passes through the document reading plate portion 222. Therefore, step S9 is also processing of waiting for a time. Then, when the value of the second timer reaches the third threshold value, the processing proceeds to the next step S10.

In step S10, the trailing edge of the document G passes through the document reading plate portion 222, and therefore, the reading of the document G by the image sensor 410 of the image reading device 200 is ended. Then, the processing proceeds to the next step S11.

In step S11, it is determined whether the conveyed document detector 130 outputs the output signal Low or not. Here, when the output signal is not Low, it can be determined that the document G is stopped, and the processing proceeds to step S5 described above to perform the retracting operation. When the output signal is LOW, the processing proceeds to step S12.

In step S12, it is determined whether the placed document detector 340 outputs the output signal Low or not. When the output signal Low is not output, there is the document G on the document placement portion 301, and the processing returns to step S2 to start reading the next document G, and when the output signal is Low, the processing proceeds to step S13.

In step S13, the clutch is connected, and the driving source 316 is rotated in the second direction and stopped, thereby performing the end operation of moving the roller holder 314 to the raised position. As a result, the document stopper 16 is located at the first position (regulating position), and the second reading processing is ended. That is, the second reading processing is ended in a state where the engaging portion 161a of the document stopper 16 is engaged with the engaged portion 314a of the roller holder 314 at a first engaging position P1.

Next, by using FIG. 20, the return operation performed by the controller 15 after the post-processing information is displayed on the operation display 120 in step S5 will be described.

After the post-processing information is displayed on the operation display 120 in step S5, that is, in a state where a value of the jamming determination flag is 1, the controller 15 determines whether the placed document detector 340 outputs the output signal Low or not in step S14. Here, when the output signal Low is detected, the processing proceeds to the next step S15, and when the output signal Low is not detected, the processing does not proceed to the next step S15 and enters a waiting state.

In step S15, the controller 15 rotates the driving source 316 in the first direction and connects the clutch to cause the holder mover 305 to move the roller holder 314 to the lowered position. Then, the state of being located at the lowered position is kept for a predetermined time, to move the document stopper 16 to the first position (regulating position) by its own weight. Thereafter, the driving source 316 is rotated in the second direction, the roller holder 314 is moved to the raised position by the holder mover 305, and the holding regulating portion 17 is caused to hold the document stopper 16 at the first position. Then, the value of the jamming determination flag is set to 0 to make it possible to check a non-jammed state. In this manner, in step S15, the return operation is performed so that the document stopper 16 is held at the first position, and then the return operation is ended with the second reading processing performable. In other words, the operation of rotating the driving source 316 in the predetermined first direction and rotating the driving rotary shaft 3121a in the predetermined forward rotation direction Ra is performed for a first time of period to move the roller holder 314 to the lowered position, and then the driving source 316 is rotated in the second direction opposite to the first direction to rotate the driving rotary shaft 3121a in the reverse rotation direction Rb for a predetermined second period of time to move the roller holder 314 to the raised position, and the return operation is ended.

As described above, the document feeding device 300 of the embodiment includes the document placement portion (sheet placement portion) 301 on which the document G (sheet G) is placed, the document conveyance path (sheet conveyance path) W3 through which the document G is conveyed, the document feeder (sheet feeder) 310 that feeds the document G placed on the document placement portion 301 to the document conveyance path W3, the conveyed document detector (conveyed sheet detector) 130 that detects the document G being conveyed through the document conveyance path W3, and the controller 15.

The document feeder 310 includes the feeding roller 311 that rotates about the rotation axis α by receiving the rotational driving force from the driving source 316 and the roller holder 314 that pivotally supports the feeding roller 311, the holder mover 305 that moves the roller holder 314 to the lowered position where the feeding roller 311 abuts against the document G placed on the document placement portion 301 or to the raised position where the feeding roller 311 is separated from the document G placed on the document placement portion 301, and the document stopper (sheet stopper) 16 movable (swingable) to the first position where the feeding of the document G placed on the document placement portion 301 to the document conveyance path W3 is regulated and the second position where the feeding of the document G placed on the document placement portion 301 to the document conveyance path W3 is not regulated (in the state where the roller holder 314 is located at the lowered position), that are provided above the document placement portion 301.

The controller 15 can perform the feeding operation of moving the roller holder 314 to the lowered position and feeding the document G placed on the document placement portion 301 to the document conveyance path W3 by the feeding roller 311, and the retracting operation of stopping the feeding operation of the feeding roller 311 and moving the roller holder 314 to the raised position when it is determined that the document G fed by the feeding operation is stopped in the document conveyance path W3 based on a detection result of the conveyed document detector 130.

The document feeder 310 further includes the holding regulating portion 17 that holds the document stopper 16 so as not to move from (the state of being located at) the second position when the retracting operation is performed in a state where the document stopper 16 is located at the second position (being the non-regulating position by the stopped document G).

Therefore, even when the document G stops for some reason during the conveyance through the document conveyance path W3 and the retracting operation is performed in a state where the document stopper 16 abuts against the stopped document G and is located at the second position, the holding regulating portion 17 holds the document stopper 16 at the second position, and thus, even when the stopped document G is pulled out, the document G can be prevented from being damaged by the document stopper 16.

Further, the document feeding device 300 of the embodiment further includes the opening/closing member 303 (including the document guide rib 3031) movable to the open position to open a part of the upper side of the document conveyance path W3 and to the closed position to form the document conveyance path W3, and the drive transmitter 304 that transmits the rotational driving force from the driving source 316 to the feeding roller 311 and the holder mover 305 in the state where the opening/closing member 303 is located at the closed position and does not transmit the rotational driving force from the driving source 316 to the feeding roller 311 and the holder mover 305 in the state where the opening/closing member 303 located at the open position, and the holder mover 305 is capable of moving the roller holder 314 to the lowered position or the raised position by the rotational driving force from the driving source 316 in the state where the opening/closing member 303 is located at the closed position, the document feeder 310 further includes the biasing member 330 that is provided at the opening/closing member 303 and applies, to the roller holder 314, the biasing force that allows the roller holder 314 to hold the raised position even when the opening/closing member 303 is moved to the open position in the state where the roller holder 314 is located at the raised position.

With this formation, even when the opening/closing member 303 is opened after the retracting operation where the document stopper 16 is held at the second position by the holding regulating portion 17, the document stopper 16 is held at the second position, and thus, even when the user forgets to take the document G remaining on the document placement portion 301 and moves the opening/closing member 303 to the closed position, it is possible to prevent the document G from being damaged by the document stopper 16.

The document stopper 16 is formed to be located at the first position by its own weight in the state where the roller holder 314 is located at the lowered position and there is no document G on the document placement portion 301, and the document feeding device 300 of the embodiment further includes the placed document detector 340 that detects whether the document G is placed on the document placement portion 301 or not. Therefore, the controller 15 stops the feeding operation of the document G after the time point at which it is determined that the document G is not present on the document placement portion 301 based on a detection result of the placed document detector 340 during the feeding operation of the document G, and performs the preparation operation of moving the roller holder 314 from the lowered position to the raised position from a state where the document stopper 16 is located at the first position by its own weight to enter the feeding preparation state, and in the feeding preparation state, the document stopper 16 is held by the holding regulating portion 17 so as not to move from the first position.

In the feeding preparation state, the document stopper 16 is held by the holding regulating portion 17 so as not to move from the first position. Therefore, when the next second reading processing is performed, the documents G placed on the document placement portion 301 can be caused to abut against the stopper portion 162a of the document stopper 16 to be aligned.

The document feeding device 300 of the embodiment further includes the operation display 120 that notifies the operator of information. When the document G is stopped for some reason during the conveyance through the document conveyance path W3 and the retracting operation is performed, the controller 15 sets the value of the jamming determination flag to 1 and then displays the post-processing information (see FIG. 21) to prompt removal of the documents G remaining on the document conveyance path W3 and the document placement portion 301 on the operation display 120. Then, after the post-processing information is displayed on the operation display 120 (that is, while the jamming determination flag is 1), when it is determined that the document G is not present on the document placement portion 301 based on a detection result of the placed document detector 340, the return operation of moving the roller holder 314 to the lowered position, bringing the document stopper 16 into the state of being located at the first position (by its own weight), moving the roller holder 314 to the raised position, and bringing the document stopper 16 into the state of being held at the first position by the holding regulating portion 17 is performed, and the jamming determination flag is changed to 0.

Therefore, even when the document G is stopped for some reason during the conveyance of the document G through the document conveyance path W3 and the retracting operation is performed, the controller 15 can automatically perform the return operation based on a detection result of the placed document detector 340 and return the document stopper 16 to the first position being the regulating position. That is, the second reading processing is prepared to be performed next.

Here, the engaging portion 161a of the document stopper 16 includes the first engaging portion 161a1 located on the upstream side in the document feeding direction H and the second engaging portion 161a2 located on the downstream side in the document feeding direction H, and when in the feeding preparation state, the first engaging portion 161a1 engages with the engaged portion 314a, and when the retracting operation is performed and the document stopper 16 is held at the second position by the holding regulating portion 17, the second engaging portion 161a2 engages with the engaged portion 314a.

Since the engaging portion 161a includes the first engaging portion 161a1 and the second engaging portion 161a2 as described above, the holding regulating portion 17 can hold the document stopper 16 at the first position or the second position by the roller holder 314 moving to the raised position.

### 2. Second Embodiment

Here, an example of control by the controller 15 for the document feeding device 300 different from that of the first embodiment will be described. Only one difference from the first embodiment is the return operation when a jam occurs where the document G is stopped during the second reading processing.

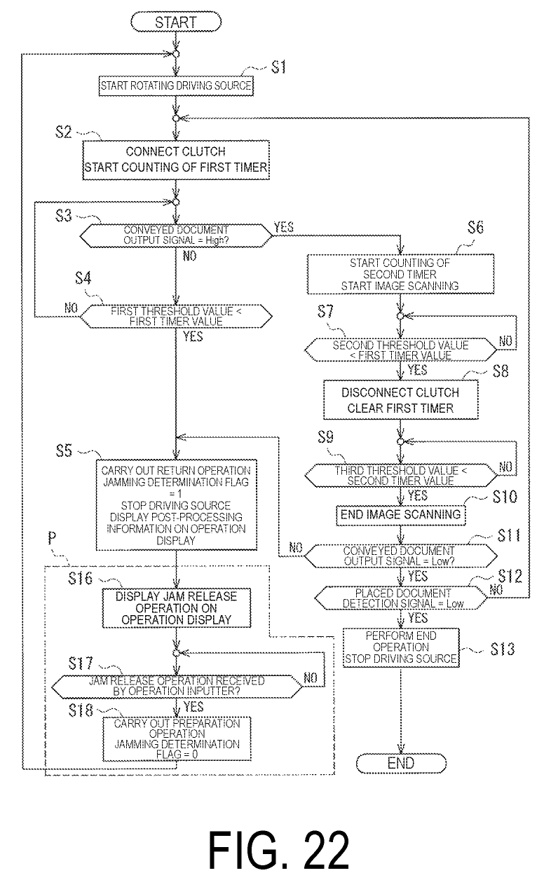

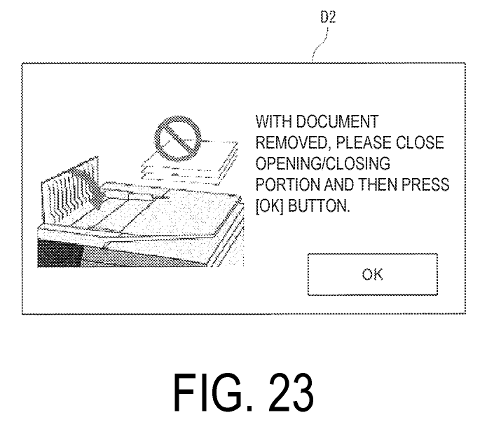

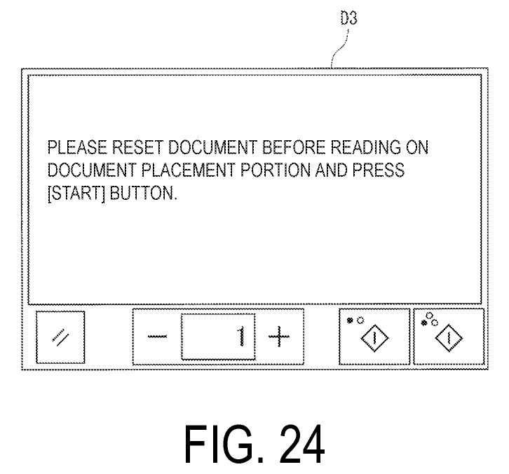

FIG. 22 is a control flow of the second reading processing in the second embodiment. FIGS. 23 and 24 are examples of the post-processing information (second display screen D2 and third display screen D3) to prompt removal of the document G displayed on the operation display 120 when the retracting operation is performed in the flow in FIG. 22.

The second embodiment is different from the first embodiment in processing of P surrounded by a broken line in FIG. 22, that is, processing from step S16 to step S18, and the other processing is the same as that of the first embodiment, and thus the description of the other processing will be omitted here.

The processing from step S16 to step S18 is a process flow related to the return processing from the state (retracted state) where the document G is stopped in the document conveyance path W3 during the second reading processing. In step S16 carried out after the controller 15 determines that the document G is stopped in the document conveyance path W3 and performs step S5, a jam release operation as illustrated in FIG. 23 is displayed on the operation display 120. Since the operation display 120 of the second embodiment is a touch panel, when an OK button displayed on the screen is pressed, the same return operation as that performed in the first embodiment is performed, and an operation screen to restart the feeding of the document G as illustrated in FIG. 24 is displayed on the operation display 120.

That is, the document feeding device 300 according to the second embodiment further includes the operation display 120 capable of displaying information to a user (operator) and receiving a predetermined operation, that is, the display that displays information and the operation inputter that receives the predetermined operation, the controller 15 displays the post-processing information indicating the predetermined operation of removing the documents G remaining on the document conveyance path W3 and the document placement portion 301 on the display (see FIG. 23) after the retracting operation is performed in step S5, and when the operation inputter receives the predetermined operation displayed in the post-processing information, the controller 15 performs the return operation of moving the roller holder 314 to the lowered position, bringing the document stopper 16 into the state of being located at the first position, moving the roller holder 314 to the raised position, and bringing the document stopper 16 into the state of being held at the first position by the holding regulating portion 17. Then, after the return operation is performed, the operation display 120 is caused to display information to instruct a feeding restart operation of the document G (see FIG. 24).

Note that the return operation may be performed after it is determined that the document G is not present on the document placement portion 301 from a detection result of the placed document detector 340.

As described above, the post-processing information indicating the operation of removing the document G stopped in the document conveyance path W3 is displayed on the operation display 120, and the return processing is performed based on operation information received from the user, so that even when the document G is stopped in the document conveyance path W3, the conveyance can be easily restarted.

The disclosure is not limited to the embodiments described above and can be embodied in other specific forms. The present embodiments are therefore to be considered in all respects as illustrative and not restrictive. The scope of the present disclosure is indicated by the claims, and is not restricted by the description in the specification. Furthermore, all modifications and alterations falling within the equivalent scope of the claims are included within the scope of the present disclosure.

What is claimed is:

1. A sheet feeding device, comprising:
a sheet placement portion on which a sheet is placed;
a sheet conveyance path through which the sheet is conveyed;
a sheet feeder that feeds the sheet placed on the sheet placement portion to the sheet conveyance path;
a conveyed sheet detector that detects the sheet being conveyed through the sheet conveyance path; and
one or more controllers, wherein
the sheet feeder includes
a feeding roller that rotates about a rotation axis by receiving a rotational driving force from a driving source,
a roller holder that pivotally supports the feeding roller,
a holder mover that moves the roller holder to a lowered position where the feeding roller abuts against the sheet placed on the sheet placement portion or to a raised position where the feeding roller is separated from the sheet placed on the sheet placement portion, and
a sheet stopper provided above the sheet placement portion and movable to a first position where feeding of the sheet placed on the sheet placement portion to the sheet conveyance path is regulated and to a second position where the feeding of the sheet placed on the sheet placement portion to the sheet conveyance path is not regulated,
the one or more controllers are allowed to perform
a feeding operation of moving the roller holder to the lowered position and feeding the sheet placed on the sheet placement portion to the sheet conveyance path by the feeding roller, and
a retracting operation of stopping the feeding operation of the feeding roller and moving the roller holder to the raised position in a case where it is determined that the sheet fed by the feeding operation is stopped in the sheet conveyance path based on a detection result of the conveyed sheet detector, and
the sheet feeder further includes a holding regulating portion that holds the sheet stopper so as not to move from the second position in a case where the retracting operation is performed in a state where the sheet stopper is located at the second position.

2. The sheet feeding device according to claim 1, further comprising an opening/closing member movable to an open position to open a part of an upper side of the sheet conveyance path and to a closed position to form the sheet conveyance path, wherein
the holder mover is allowed to move the roller holder to the lowered position or to the raised position by a rotational driving force from the driving source in a state where the opening/closing member is located at the closed position, and
the sheet feeder further includes a biasing member that is provided at the opening/closing member and applies a biasing force that allows the roller holder to hold the raised position to the roller holder even in a case where the opening/closing member is moved to the open position in a state where the roller holder is located at the raised position.

3. The sheet feeding device according to claim 2, wherein
the sheet stopper is located at the first position by weight of the sheet stopper in a state where the roller holder is located at the lowered position and the sheet is not present on the sheet placement portion.

4. The sheet feeding device according to claim 3, further comprising a placed sheet detector that detects whether the sheet is placed on the sheet placement portion or not, wherein
after a time point at which it is determined that the sheet is not present on the sheet placement portion based on a detection result of the placed sheet detector during the feeding operation, the one or more controllers stop the feeding operation, and perform a preparation operation of moving the roller holder to the raised position from a state where the sheet stopper is located at the first position to enter a feeding preparation state, and
in the feeding preparation state, the sheet stopper is held by the holding regulating portion so as not to move from the first position.

5. The sheet feeding device according to claim 4, further comprising a display that notifies an operator of information, wherein
the one or more controllers
display post-processing information to prompt removal of the sheet remaining on the sheet conveyance path and the sheet placement portion on the display in a case where the retracting operation is performed, and
after the post-processing information is displayed on the display, in a case where it is determined that the sheet is not present on the sheet placement portion based on a detection result of the placed sheet detector, perform a return operation of moving the roller holder to the lowered position, bringing the sheet stopper into a state of being located at the first position, moving the roller holder to the raised position, and bringing the sheet stopper into a state of being held at the first position by the holding regulating portion.

6. The sheet feeding device according to claim 5, further comprising an operation inputter that receives a predetermined operation by an operator, wherein
the one or more controllers
display the post-processing information indicating the predetermined operation of the removal of the sheet remaining on the sheet conveyance path and the sheet placement portion on the display in the case where the retracting operation is performed, and
in a case where the operation inputter receives the predetermined operation displayed in the post-processing information, perform the return operation of moving the roller holder to the lowered position, bringing the sheet stopper into the state of being located at the first position, moving the roller holder to the raised position, and bringing the sheet stopper into the state of being held at the first position by the holding regulating portion.

7. The sheet feeding device according to claim 2, wherein
the sheet stopper and the roller holder are provided so as to be adjacent to each other in a rotation axis direction of the feeding roller,
the holding regulating portion includes
an engaged portion provided at the roller holder, and
an engaging portion provided at the sheet stopper and allowed to engage with the engaged portion,
the engaged portion is an engaged protruding portion that protrudes from the roller holder toward the sheet stopper side,
the engaged portion is located at a position where the engaged portion is not engaged with the engaging portion in a state where the roller holder is located at the lowered position, and
the engaged portion is located at a position where the engaged portion is engaged with the engaging portion in the state where the roller holder is located at the raised position.

8. The sheet feeding device according to claim 7, wherein
the sheet stopper includes the engaging portion, a stopper portion that abuts against the sheet placed on the sheet placement portion, and a first swing shaft portion that turns about a first swing axis along a rotation axis direction of the feeding roller,
the engaging portion and the stopper portion are provided at different positions in a circumferential direction of the first swing shaft portion,
the stopper portion includes a flat surface portion that abuts against one end of a plurality of the sheets placed on the sheet placement portion and aligns end positions of the plurality of sheets.

9. The sheet feeding device according to claim 8, wherein
the sheet stopper includes a first arm portion extending from the first swing shaft portion in a radial direction of the first swing shaft portion, and a second arm portion extending from a peripheral surface of the first swing shaft portion where the first arm portion is not provided, in the radial direction of the first swing shaft portion,
the engaging portion is an engaging protruding portion provided at a tip end portion of the first arm portion so as to protrude toward the roller holder side,
the flat surface portion is provided so as to extend from a tip end portion of the second arm portion to a side opposite to the engaging portion in a direction intersecting with an extending direction of the second arm portion, and
the first arm portion and the second arm portion are located on a downstream side with respect to a virtual vertical line passing through the first swing axis in a feeding direction of the sheet in a state where the document stopper is located at a first position.

10. The sheet feeding device according to claim 9, wherein
the engaging portion includes a first engaging portion located on an upstream side in the feeding direction and a second engaging portion located on a downstream side in the feeding direction, and
the first engaging portion engages with the engaged portion in a case of being in a feeding preparation state, and the second engaging portion engages with the engaged portion in a case where the retracting operation is performed and the sheet stopper is held at the second position by the holding regulating portion.

11. The sheet feeding device according to claim 8, wherein
the opening/closing member includes a plurality of guide ribs that form the sheet conveyance path and extend along a feeding direction of the sheet,
the sheet stopper is supported between the plurality of guide ribs so as to be swingable about the first swing axis, and
the roller holder is provided at the guide rib so as to be freely swingable about a second swing axis along the rotation axis direction of the feeding roller.

12. The sheet feeding device according to claim 11, wherein
the guide rib is provided with a rotation stopping portion that regulates swinging of the stopper portion of the sheet stopper located at the first position to an upstream side in the feeding direction of the sheet.

13. An image reading device, comprising the sheet feeding device according to claim 1, wherein
an image scanner is provided at a position facing the sheet conveyance path of the sheet feeding device.

14. An image forming apparatus, comprising the image reading device according to claim 13.
